(19) United States
(12) Patent Application Publication
(10) Pub. No.: US 2026/0241849 A1
(43) Pub. Date: Aug. 20, 2026

(54) System, Apparatus, Assembly, And Method For Moving Stackable Items

(71) Applicant: NILEC SOLUTIONS, LLC, Houston, TX (US)

(72) Inventor: TIMOTHY ALLEN NIEDZWIECKI, Atlantic Mine, MI (US)

(21) Appl. No.: 19/536,028

(22) Filed: Feb. 10, 2026

Related U.S. Application Data
(60) Provisional application No. 63/759,539, filed on Feb. 17, 2025.

(51) Int. Cl. B60P 1/44; B60P 1/00; B66F 7/06; B66F 11/04

(52) U.S. Cl. CPC B60P 1/4421; B60P 1/00; B66F 7/0666; B66F 11/042

(57) ABSTRACT

The disclosure is directed to a system, apparatus, assembly, and method configured for moving a load or a portion of a load, including but not limited to stackable items, from a first support surface to one or more other support surfaces. The system, apparatus, assembly, and method may include components configured to position and direct the load or portion of the load for controlled transfer between support surfaces in an automated or user-assisted manner, including positioning elements adapted to align a selected portion of the load with a receiving support surface for transfer, and may be adapted for use with a variety of load types and operational environments.

### CROSS-REFERENCE TO RELATED APPLICATIONS

This application claims benefit of U.S. Provisional Patent Application No. 63/759,539, filed on Feb. 17, 2025, the content of which is hereby incorporated by reference in its entirety.

### BACKGROUND OF THE DISCLOSURE

### 1. Field of the Disclosure

The present disclosure relates generally to the movement or transfer of items onto, from, or between support surfaces.

### 2. Background Art

In industrial, warehouse, and other material-handling environments, items are commonly placed on support surfaces such as pallets, skids, platforms, or similar structures for transport and storage. Such items may be arranged individually, in rows, in groups, or in stacked configurations depending on operational needs. Efficiency in moving such items from a support surface onto one or more other support surfaces is desired.

### SUMMARY OF THE DISCLOSURE

The present disclosure provides an assembly comprising (1) a first subsystem; and (2) a second subsystem; wherein the first subsystem is configured to support a load and to effect movement of the load or a portion of the load toward the second subsystem; and wherein the second subsystem is configured to receive the load or the portion of the load from the first subsystem and to reposition the load or the portion of the load from a first location within the second subsystem to a second location within the second subsystem.

The present disclosure also provides an assembly, comprising (1) a first subsystem configured to support a load; and (2) a second subsystem operatively associated with the first subsystem; wherein the first subsystem includes a load-moving system comprising an off-loading support surface configured to be directed to one or more off-loading positions, each off-loading position corresponding to a vertical position of the off-loading support surface selected according to a configuration of an intended portion of the load to be transferred to the second subsystem; and wherein when the off-loading support surface is set to a first off-loading position, then the vertical position of the off-loading support surface corresponds to a vertical position associated with the intended portion of the load to be transferred to the second subsystem, and the load-moving system is configured to initiate movement of the intended portion of the load toward the second subsystem.

The present disclosure also provides a method, comprising moving stackable items off a portable load-carrying load-bearing member using an assembly, including (1) a first subsystem configured to hold the portable load-carrying load-bearing member with the stackable items thereon; and (2) a second subsystem configured to receive the stackable items from the first subsystem; positioning the stackable items at a first location within the second subsystem; and repositioning the stackable items from the first location to a second location within the second subsystem.

### BRIEF DESCRIPTION OF THE SEVERAL VIEWS OF THE DRAWINGS

FIG. 1 is a side elevation view depicting rows of bundles of roof shingles stacked in rows on top of an embodiment of a portable load-carrying load-bearing member.

FIG. 2 is a perspective view of an embodiment of an assembly of this disclosure.

FIG. 3 is a perspective view of an embodiment of an assembly of this disclosure including a portable load bearing member holding bundles of roof shingles on an off-loading platform of the assembly and a first portable load-receiving load-bearing member located on a loading platform of the assembly.

FIG. 4 is a perspective view of an embodiment of a main frame of an assembly of this disclosure.

FIG. 5 is a top view of the main frame of FIG. 4.

FIG. 6 is a perspective view of an embodiment of an off-loading platform of an assembly of this disclosure.

FIG. 7 is a perspective view of the off-loading platform of FIG. 6.

FIG. 8 is a detailed perspective view of a U-shaped connector of the off-loading platform of FIG. 7.

FIG. 9 is a perspective view of a rear cover plate of an off-loading platform of an assembly of this disclosure.

FIG. 10 is a perspective view of part of an off-loading assembly of an assembly of this disclosure.

FIG. 11 is a side elevation view of a first frame member of the off-loading platform of FIG. 6.

FIG. 12 is a side elevation view of a second frame member of the off-loading platform of FIG. 6.

FIG. 13 is a front elevation view of a stop member of the off-loading platform of FIG. 7.

FIG. 14 is a right side elevation view of the stop member of FIG. 13.

FIG. 15 is a perspective view of the stop member of FIG. 13.

FIG. 16 is a perspective view of the main frame of FIG. 4 including a push assembly.

FIG. 17 is a detailed perspective view of part of the push assembly of FIG. 16.

FIG. 18 is a detailed perspective view of part of the push assembly of FIG. 16.

FIG. 19 is a perspective view of a push member of the push assembly of FIG. 16.

FIG. 20 is a top view of the push member of FIG. 19.

FIG. 21 is a side elevation view of the push member of FIG. 19.

FIG. 22 is a front elevation view of the push member of FIG. 19.

FIG. 23 is a perspective view of the push member of FIG. 19.

FIG. 24 is a perspective view of part of a loading assembly of an assembly of this disclosure including a loading platform of the loading assembly set apart from the main frame of the loading assembly.

FIG. 25 is a perspective view of part of the loading assembly of FIG. 24.

FIG. 26 is an elevation view of a support member of the loading assembly of FIG. 24.

FIG. 27 is a perspective view of the loading assembly of FIG. 24 including a moveable cover member in a non-operating position.

FIG. 28 is a perspective view of the moveable cover member of FIG. 27.

FIG. 29 is a perspective view of the moveable cover member of FIG. 27.

FIG. 30 is a perspective view of the moveable cover member of FIG. 27.

FIG. 31 is a perspective view of an embodiment of an assembly of this disclosure including a moveable cover member in an operating position.

FIG. 32 is a perspective view of the assembly of FIG. 31 including a portable load-carrying load-bearing member holding stacked rows of bundles of roof shingles on an off-loading platform of the assembly and a first portable load-receiving load-bearing member located on a loading platform of the assembly with a moveable cover member set in a non-operating position.

FIG. 33 is a perspective view of the assembly of FIG. 32 including the off-loading platform set to a first off-loading position and the moveable cover member set in an operating position.

FIG. 34 is a perspective view of the assembly of FIG. 33 including a push member of the assembly in an extended position and an upper load portion of the stacked rows of bundles of roof shingles located on an outer surface of a top cover of the moveable cover member.

FIG. 35 is a perspective view of the assembly of FIG. 34 including the moveable cover member set to a non-operating position and the upper load portion of the stacked rows of bundles of roof shingles located on the first portable load-receiving load-bearing member on the loading platform.

FIG. 36 is a perspective view of the assembly of FIG. 35 including the push member set to a retracted position, the off-loading platform set to a second off-loading position and the moveable cover member set to the operating position.

FIG. 37 is a perspective view of the assembly of FIG. 36 including the push member in an extended position and a lower load portion of the stacked rows of bundles of roof shingles located on the outer surface of a top cover of the moveable cover member.

FIG. 38 is a perspective view of the assembly of FIG. 37 including the moveable cover member set to a non-operating position and a second portable load-receiving load-bearing member holding the lower load portion of the stacked rows of bundles of roof shingles depicted as being lifted off from the loading platform of the assembly.

FIG. 39 is a perspective view of an embodiment of an assembly of this disclosure including a moveable cover member in a non-operating position and an uppermost row of an upper load portion of stacked rows of bundles of roof shingles located on a first portable load-receiving load-bearing member on a loading platform of the assembly.

FIG. 40 is a perspective view of the assembly of FIG. 39 including the moveable cover member in a non-operating position and an uppermost row of a lower load portion of the stacked rows of bundles of roof shingles located on a second portable load-receiving load-bearing member on the loading platform of the assembly.

FIG. 41 is a perspective view of an embodiment of a hydraulic powering system of an assembly of this disclosure.

FIG. 42 is a rear elevation view of the hydraulic powering system of FIG. 41.

FIG. 43 is a side elevation view of the hydraulic powering system of FIG. 41.

FIG. 44 is a top view of the hydraulic powering system of FIG. 41.

### DEFINITIONS USED IN THE DISCLOSURE

Terms and phrases used in this disclosure, and variations thereof, unless otherwise expressly stated, should be construed as open-ended as opposed to limiting. As examples of the foregoing: the term “including” should be read as meaning “including, without limitation” and/or the like, the term “example” is used to provide exemplary instances of the item in discussion, not an exhaustive or limiting list thereof, the terms “a” or “an” should be read as meaning “at least one,” “one or more,” and/or the like. The use of the term “assembly” does not imply that the components or functionality described or claimed as part of an assembly are all necessarily configured in a common package.

The term “at least one”, “one or more”, and “one or a plurality” mean one thing or more than one thing with no limit on the exact number; these three terms may be used interchangeably within this disclosure. For example, at least one device means one or more devices or one device and a plurality of devices.

The term “about” means that a value of a given quantity is within ±20% of the stated value. In other embodiments, the value is within ±15% of the stated value. In other embodiments, the value is within ±10% of the stated value. In other embodiments, the value is within ±7.5% of the stated value. In other embodiments, the value is within ±5% of the stated value. In other embodiments, the value is within ±2.5% of the stated value. In other embodiments, the value is within ±1% of the stated value.

The term “substantially” or “essentially” means that a value of a given quantity is within ±10% of the stated value. In other embodiments, the value is within ±7.5% of the stated value. In other embodiments, the value is within ±5% of the stated value. In other embodiments, the value is within ±2.5% of the stated value. In other embodiments, the value is within ±1% of the stated value. In other embodiments, the value is within ±0.5% of the stated value. In other embodiments, the value is within ±0.1% of the stated value.

The term “and/or” includes any and all combinations of one or more of the associated listed items.

The terms “first,” “second,” “third,” and/or the like, herein do not denote any order, quantity, or importance, but rather are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable. For example, in some circumstances, an event or capacity can be expected, while in other circumstances, the event or capacity cannot occur. This distinction is captured by the terms “may” and “may be.”

As used in this disclosure, the terms “unit load” and “load” refer to one or more items that may be moved using an assembly as described herein. For purposes of this disclosure, separating a load into at least two separate smaller loads may be referred to herein as “splitting” a load.

Herein, “HP” refers to horsepower. Herein, “cSt” refers to centistokes. Herein, “VAC” refers to volts alternating current. Herein, “psi” refers to pounds-per-square-inch. Herein, “JIC” refers to Joint Industry Council. Herein, “UHMW” refers to ultra-high-molecular-weight polyethylene. Herein, “ABS” refers to acrylonitrile butadiene styrene.

As used herein, the term “skilled artisan” refers to a person having ordinary skill in the relevant art, possessing the customary technical knowledge and experience of that art at the time of the invention.

### DETAILED DESCRIPTION OF THE DISCLOSURE

For the purposes of promoting an understanding of the principles of the disclosure, reference is now made to the embodiments illustrated in the drawings, and particular language will be used to describe the same. It is to be understood that the present disclosure is not limited to particular embodiments. It is also to be understood that the terminology used herein is for the purpose of describing particular embodiments only, and is not intended to be limiting. For purposes of this disclosure, items of a load that may be stacked and moved using a system, apparatus, assembly, or method of this disclosure may include, without limitation, cube-shaped items of various dimensions stackable in rows, cuboid-shaped items of various dimensions stackable in rows, items having a sheet-material-type configuration stackable in rows, items having an elongated plank-type configuration stackable in rows, cylindrical-shaped items stackable in rows, and rolled-up items stackable in rows. Examples of cube-shaped items may include, but are not limited to, cube-shaped boxes, cube-shaped containers, and cube-shaped solid objects. Examples of cuboid-shaped items may include, but are not limited to, cuboid-shaped boxes, cuboid-shaped containers, and cuboid-shaped solid objects. Although some variation may exist in dimensions realized, for purposes of this disclosure, bundles of roofing shingles may be considered to be packaged in a generally cuboid shape. Examples of items having a sheet-material-type configuration include, but are not limited to, drywall, plywood, board material, glass, and plastic sheet-type building materials. Examples of items having an elongated plank-type configuration may include, but are not limited to, dimensional lumber, dimensional foam, dimensional plastic, and dimensional composite materials. Examples of cylindrical-shaped items include, but are not limited to, pipe and other tubular items, solid cylindrical items such as metal cylinders, plastic cylinders, composite cylinders, wood cylinders, stone cylinders, and foam cylinders. Examples of rolled-up items include, but are not limited to, carpet, wire mesh, roll roofing, galvanized steel rolls, insulation rolls, and rolled fence material. Herein, the terms “bundles of roof shingles,” “bundles of shingles,” “shingle bundles,” and the like may be used interchangeably.

For purposes of this disclosure, the term “load bearing member” may include, but is not necessarily limited to one or more pallets, skids, crates, cartons, baskets, containers, receptacles, cages, racks, trays, boxes, portable platform assemblies, and combinations thereof configured to hold stackable items and/or non-stackable items thereon. As understood by the skilled artisan, a common pallet used in industry is characterized by a top deck portion and a bottom deck portion for structural support and a skid used in industry is characterized by a single-deck without a bottom deck portion. Non-limiting examples of pallets may include two-way pallets and four-way pallets as such terms are known in the art. Exemplary two-way pallet styles may include, but are not limited to (1) reversible pallets, (2) closed boarded, no base board pallets, and (3) wing type pallets. Exemplary four-way pallets may include, but are not limited to (1) close boarded, three base pallets, (2) perimeter base pallets, (3) wing type pallets, (4) close boarded, perimeter base pallets, and (5) open boarded, three base pallets. Another exemplary pallet may include a EUR pallet as such term is understood by the skilled artisan. Commercially available pallets and skids may be constructed from materials including, but not limited to one or more woods, one or more pressed woods, one or more plastics, one or more rubbers, one or more metals, one or more cardboard materials, one or more composite materials, and combinations thereof. Non-limiting examples of a portable platform assembly for use herein are described in U.S. Pat. No. 11,802,024, titled “System and Method for the Transport and Holding of Building Materials,” issued on Oct. 31, 2023; and U.S. Pat. No. 12,168,545, titled “System and Method for the Transport and Holding of Building Materials,” issued on Dec. 17, 2024; each of which is herein incorporated by reference in its entirety.

For purposes of this disclosure, one exemplary lifting device for use with a portable load bearing member may include, but is not limited to an industrial vehicle such as a forklift and/or the like. One exemplary lifting device may include a forklift having a lift capacity of at least 1.83 meters (6.0 feet). Non-limiting examples of lifting devices for purposes of this disclosure are described in U.S. Pat. No. 7,051,832B2, titled “Material Handling Vehicle with Dual Control Handles,” issued on May 30, 2006; U.S. Pat. No. 7,366,600, titled “Distributed Control System for Forklift,” issued on Apr. 29, 2008; U.S. Pat. No. 8,230,976 B2, titled Pallet Truck with Calculated Fork Carriage Height,” issued on Jul. 31, 2012; U.S. Pat. No. 9,475,513B2, titled “Pallet Truck,” issued on Oct. 25, 2016; U.S. Pat. No. 4,919,233, titled “Front Rider Lift Truck,” issued on Apr. 24, 1990; and U.S. Pat. No. 6,398,480B1, titled “Fork Lift Truck,” issued on Jun. 4, 2002; U.S. Pat. No. 11,814,274B 2, titled “Forklift,” issued on Nov. 14, 2023; each of which is herein incorporated by reference in its entirety.

In an embodiment, the disclosure is related to a system, apparatus, assembly, and method for receiving, supporting, and transferring one or more items onto or off of or from support surfaces, including portable load-bearing members.

In an embodiment, the disclosure is related to a system, apparatus, assembly, and method for moving one or more items off of or from a first portable load bearing member onto at least a second portable load bearing member. In an embodiment, the one or more items to be moved off of or from a first portable load bearing member onto at least a second portable load bearing member may include one or more stackable items. In an embodiment, the one or more items to be moved off of or from a first portable load bearing member onto at least a second portable load bearing member may include one or more stacked items (i.e., one or more items provided in a stacked orientation on top of a first portable load bearing member).

In an embodiment, the disclosure is related to a system, apparatus, assembly, and method for directing one or more items including, but not limited to one or more stackable items, off of or from at least a first portable load carrying load bearing member onto at least a first portable load receiving load bearing member. In an embodiment, the first portable load carrying load bearing member and the first portable load receiving load bearing member may be of a like kind. In an embodiment, the first portable load carrying load bearing member may be of a kind different than the first portable load receiving load bearing member.

In an embodiment, the disclosure is related to a system, apparatus, assembly, and method for directing one or more items including, but not limited to, one or more stackable items, off of or from at least a first portable load carrying load bearing member onto a plurality of portable load receiving load bearing members including at least a first portable load receiving load bearing member and a second portable load receiving load bearing member. In an embodiment, the first portable load carrying load bearing member and the first and second portable load receiving load bearing members may be of a like kind. In an embodiment, the first portable load carrying load bearing member may be of a kind different than the first portable load receiving load bearing member and/or the second portable load receiving load bearing member. In an embodiment, each of the first portable load carrying load bearing member, the first portable load receiving load bearing member and the second portable load receiving load bearing member may be of a different kind. As such, a system, apparatus, assembly, and method of this disclosure may be configured to accommodate different kinds and sizes of portable load bearing members for one or more particular operations.

In an embodiment, the disclosure is related to a system, apparatus, assembly, and method for directing one or more items including, but not limited to, one or more stackable items, off of or from at least a first portable load carrying load bearing member onto at least a first portable load receiving load bearing member and a second portable load receiving load bearing member. In an embodiment, the first portable load carrying load bearing member, the first portable load receiving load bearing member and the second portable load receiving load bearing member may be of a like kind. In an embodiment, at least one of the first portable load carrying load bearing member, the first portable load receiving load bearing member and the second portable load receiving load bearing member may be of a kind different than the other two. In an embodiment, the first portable load carrying load bearing member, the first portable load receiving load bearing member and the second portable load receiving load bearing member may each be a kind of load bearing member different than the other two. In an embodiment, the first portable load receiving load bearing member, the second portable load receiving load bearing member and any additional portable load receiving load bearing members may be of a like kind different than the first portable load carrying load bearing member and any additional portable load carrying load bearing members.

In an embodiment, the disclosure is related to the off-loading of one or more items off of or from a first portable load carrying load bearing member onto one or more load receiving load bearing members. In an embodiment, the disclosure is related to the off-loading of stackable items off of or from a first portable load carrying load bearing member onto a plurality of load receiving load bearing members in succession as described herein.

In an embodiment, the disclosure is related to an assembly for moving items including, but not limited to stackable items, off of or from a portable load carrying load bearing member onto one or more portable load receiving load bearing members. In an embodiment, the assembly may comprise a structural framework of a one-piece construction. In an embodiment, the assembly may comprise a structural framework of two or more components.

In an embodiment, the disclosure may include a system including an assembly configured to cooperate in a manner effective to move one or more items including, but not limited to, one or more stackable items, off of or from a portable load carrying load bearing member onto one or more portable load receiving load bearing members.

In an embodiment, the disclosure is related to a system including an assembly configured to hold a portable load carrying load bearing member and a first portable load receiving load bearing member in a manner effective for the first portable load receiving load bearing member to receive a first part of a load off of or from the portable load carrying load bearing member. Once the first portable load receiving load bearing member receives the first part of the load thereon, the first portable load receiving load bearing member may be removed from the assembly and replaced on the assembly with a second portable load receiving load bearing member in a manner effective for the second portable load receiving load bearing member to receive a second part of the load off of or from the portable load carrying load bearing member.

In an embodiment, the disclosure is related to an assembly configured to hold a portable load carrying load bearing member and a first portable load receiving load bearing member in a manner effective for the first portable load receiving load bearing member to receive a first part of a load off of or from the portable load carrying load bearing member. Once the first portable load receiving load bearing member receives the first part of the load thereon, the first portable load receiving load bearing member may be removed from the assembly and replaced on the assembly by a second portable load receiving load bearing member in a manner effective for the second portable load receiving load bearing member to receive a second part of the load off of or from the portable load carrying load bearing member.

In an embodiment, the disclosure is related to an assembly comprising (1) an off-loading part and (2) a loading part; wherein the off-loading part of the assembly is configured to hold a portable load carrying load bearing member; wherein the loading part of the assembly is configured to hold a first portable load receiving load bearing member; and wherein the loading part of the assembly is configured so that the first portable load receiving load bearing member may receive a first part of a load off of or from the portable load carrying load bearing member that is located on the off-loading part of the assembly. Once the first portable load receiving load bearing member receives the first part of the load thereon, the first portable load receiving load bearing member may be removed from the loading part of the assembly and a second portable load receiving load bearing member may be placed on the loading part of the assembly for receiving a second part of the load off of or from the portable load carrying load bearing member.

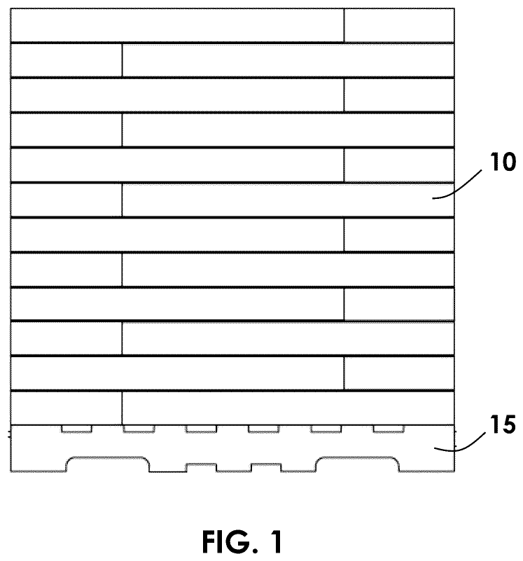

Although a system, apparatus, assembly, and method of this disclosure may include the moving or transfer of various types of items, including, but not limited to, various types of stackable items, for purpose of illustration, the disclosure is discussed in terms of moving or transferring one or more bundles of roof shingles. As shown in FIG. 1, bundles of roof shingles 10 are commonly transported and/or stored in stacked rows atop a portable load-bearing member 15, such as a pallet and/or the like as described above. As understood by the skilled artisan, roof shingle manufacturers, and others, commonly stack bundles of roof shingles 10 on pallet type load-carrying portable load-bearing members 15 in rows up to or about fifteen (15) rows including three or four bundles of roof shingles 10 per row depending on the type(s) of roof shingles in use. In an embodiment, one or more bundles of roof shingles 10 may be provided in an unstacked layout atop a portable load-bearing member 15 (e.g., one or two bundles of roof shingles 10 set atop a portable load-bearing member 15). In an embodiment, multiple unstacked bundles of roof shingles 10 may be set atop a portable load-bearing member 15 in a single row side-by-side layout or multiple unstacked bundles of roof shingles 10 may be set atop a portable load-bearing member 15 in a non-row layout (e.g., a random layout).

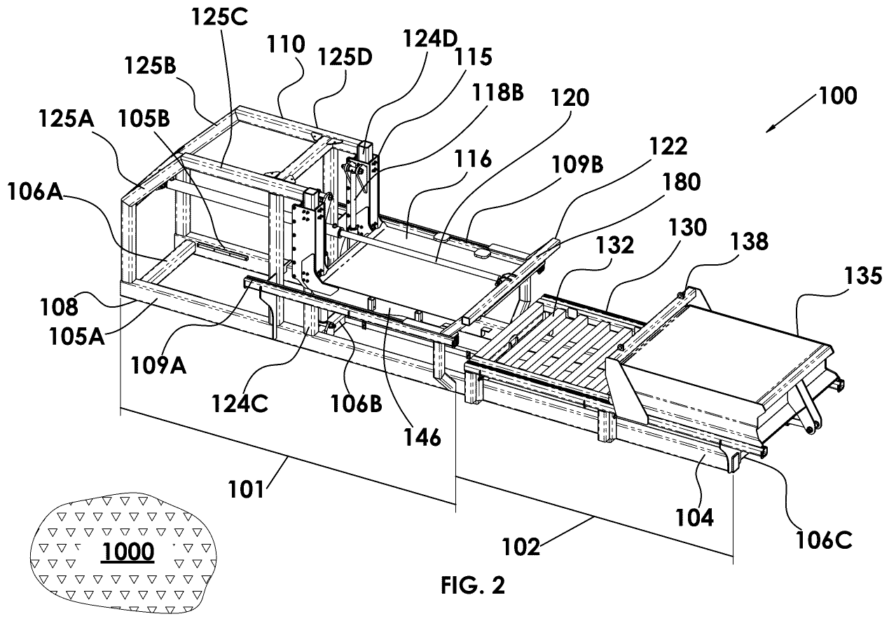

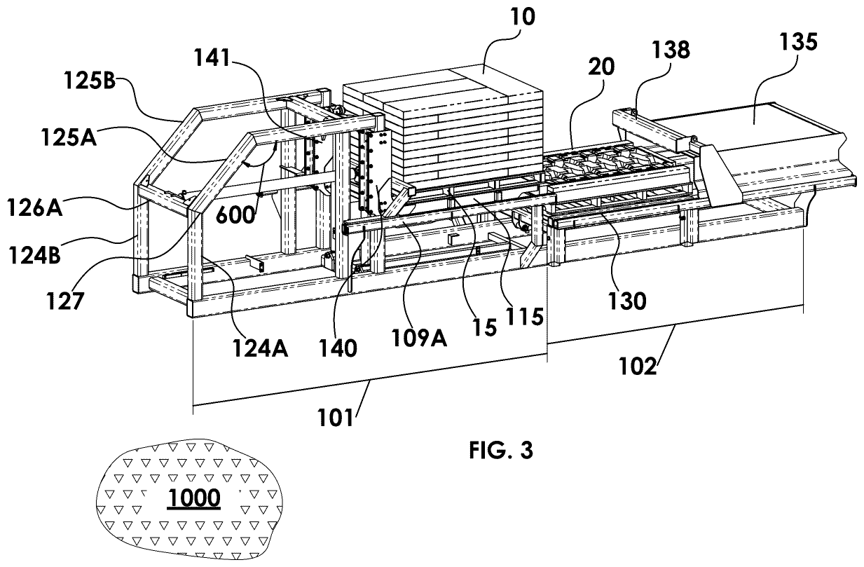

As described herein, in an embodiment, the disclosure is directed to an assembly configured to optimize the moving or transfer of one or more bundles of roof shingles 10 from a portable load-bearing member 15 (or “portable load-carrying load-bearing member 15”) onto one or more portable load-receiving load-bearing members 20. With reference to FIGS. 2 and 3, in an embodiment, an assembly 100 may comprise a first subsystem (also referred to herein as an off-loading assembly 101) configured to hold a portable load-carrying load-bearing member 15, and a second subsystem (also referred to herein as a loading assembly 102) located adjacent the off-loading assembly 101 configured to hold a portable load-receiving load-bearing member 20, wherein the assembly 100 is configured to move or transfer one or more bundles of roof shingles 10 from a portable load-carrying load-bearing member 15 located on the off-loading assembly 101 onto a portable load-receiving load-bearing member 20 located on the loading assembly 102 of the assembly 100. As described below, an assembly 100 may be configured to (1) move or transfer an entire load of one or more bundles of roof shingles 10 from a portable load-carrying load-bearing member 15 located on an off-loading assembly 101 onto a portable load-receiving load-bearing member 20 located on a loading assembly 102 and/or (2) move or transfer a portion of a load of one or more bundles of roof shingles 10 from a portable load-carrying load-bearing member 15 that is located on an off-loading assembly 101 onto a first portable load-receiving load-bearing member 20 that is located on a loading assembly 102, and when the first portable load-receiving load-bearing member 20 is removed from the loading assembly 102 and replaced with a second portable load-receiving load-bearing member 20, then the assembly 100 may move or transfer the remaining one or more bundles of roof shingles 10 or a portion of the load from the portable load-carrying load-bearing member 15 onto the second portable load-receiving load-bearing member 20.

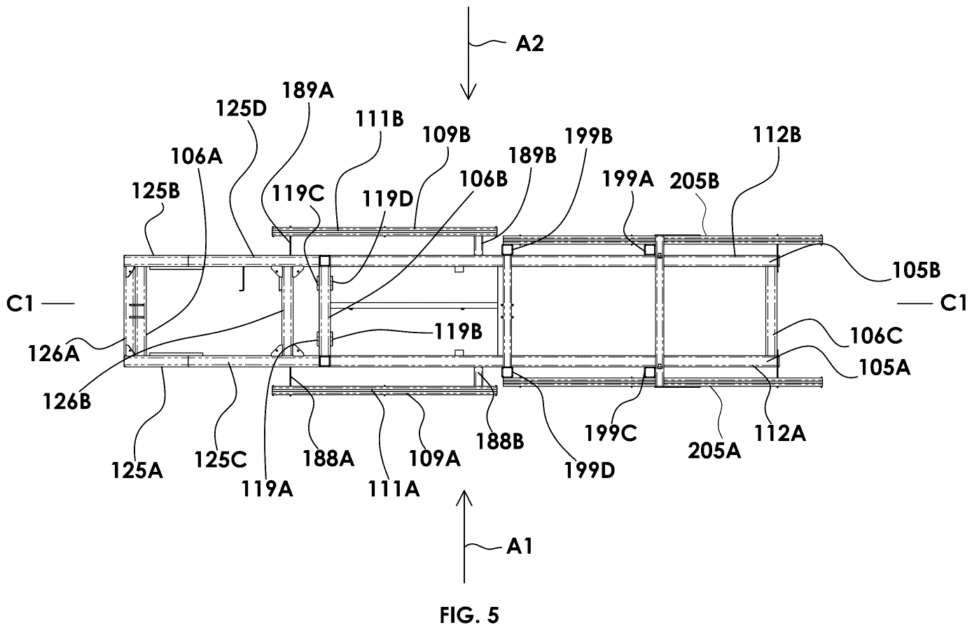

With reference to FIGS. 2-4, in an embodiment an assembly 100 may include a structural framework 103 (or “main frame 103”) including a base member 104 having parallel or substantially parallel first and second elongated members 105A and 105B common to the off-loading assembly 101 and the loading assembly 102, the first and second elongated members 105A and 105B defining a longitudinal centerline C1 (see FIG. 5) of the assembly 100. In another embodiment, an off-loading assembly 101 and a loading assembly 102 may be provided as separate members wherein each assembly has its own base member, whereby the off-loading assembly 101 and the loading assembly 102 may be releasably or permanently attached or otherwise made operable as an assembly 100 by positioning the loading assembly 102 adjacent the off-loading assembly 101 similar as shown in FIGS. 2-4 .

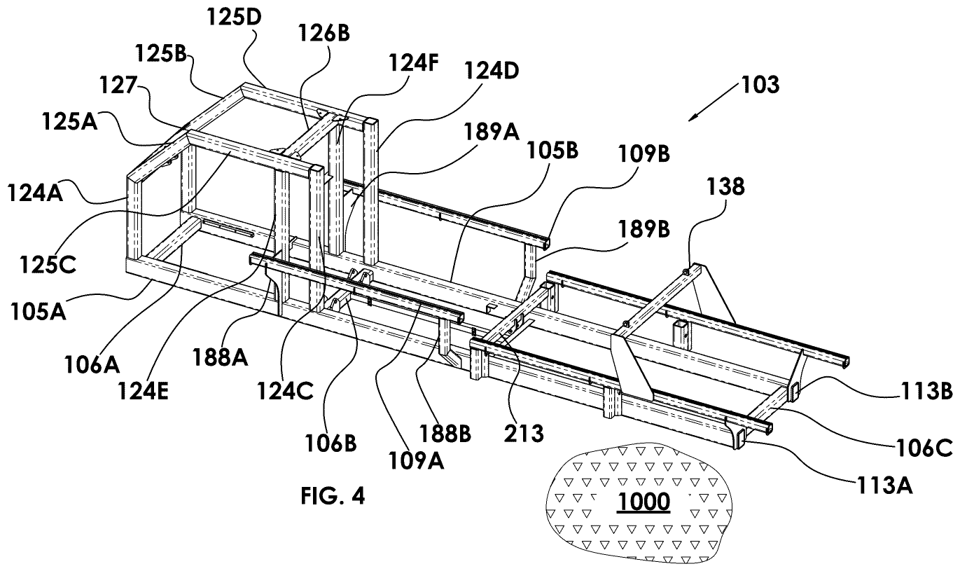

In an embodiment a base member 104 may include one or more cross members (e.g., see first, second and third cross members 106A, 106B and 106C in FIG. 4), interconnecting the first and second elongated members 105A and 105B. Suitably, one or more cross members may be located where desired or as may otherwise be required for structural integrity of the main frame 103. In an embodiment as shown, a first cross member 106A may be located at or near a first end (or “rear end”) of the base member 104, a third cross member 106C may be located at or near a second end (or “front end”) of the base member 104 and one or more second cross members 106B may be located at one or more points there between. In an embodiment, the one or more cross members 106A, 106B and 106C may be disposed perpendicular or substantially perpendicular to the first and second elongated members 105A and 105B. In an embodiment, cross members may be provided in one or more X-shape interconnections between the first and second elongated members 105A and 105B at one or more points along the base member 104.

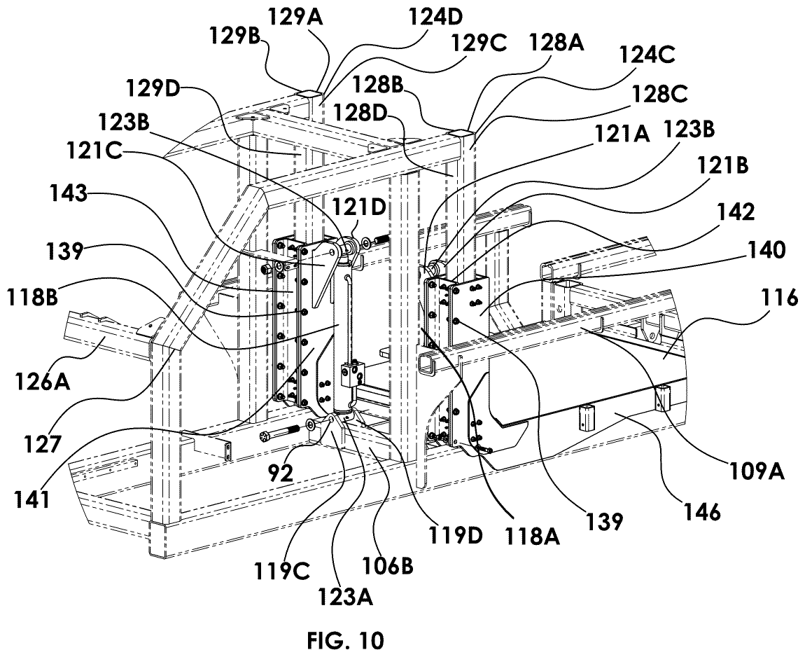

With reference to FIG. 2, in an embodiment the off-loading assembly 101 part of the main frame 103 may include a raised framework 110 extending up from the base member 104, wherein the raised framework 110 may be configured as a structural support for a load-moving system of the assembly 100. In an embodiment, a load-moving system may include (1) an adjustable platform assembly configured to receive and hold at least one portable load-carrying load-bearing member 15, and a (2) push assembly configured to push or otherwise direct a load or a portion of the load off from the portable load-carrying load-bearing member 15 onto the loading assembly 102. In an embodiment, an adjustable platform assembly may include (1) an adjustable platform 115 (or “off-loading platform 115”) having an upper planar horizontal support surface 116 configured to receive and hold a portable load-carrying load-bearing member 15 thereon (see FIG. 3) and (2) one or more first vertical actuators (e.g., one or more first vertical linear actuators 118A and 118B) (see FIG. 10) configured to direct the off-loading platform 115 vertically along the raised framework 110 in either direction to one or more set positions including, but not limited to one or more operating positions (or “off-loading positions”). In an embodiment, a push assembly may include (1) one or more first horizontal actuators (e.g., one or more first horizontal linear actuators 120), (2) one or more guide rails 109A and 109B and (3) a push member 122 slidably communicated with the one or more guide rails 109A and 109B wherein the push member 122 is configured to travel along the one or more guide rails 109A and 109B in a manner effective to move or otherwise direct a load or a portion of the load off of or from a portable load-carrying load-bearing member 15 located on the off-loading assembly 101 onto a loading assembly 102 or onto a portable load-receiving load-bearing member 20 located on a loading assembly 102.

In an embodiment, an assembly 100 may be located on a planar or substantially planar horizontal surface 1000 whereby the off-loading platform 115 is configured to hold and maintain at least one portable load-carrying load-bearing member 15 in a horizontal or substantially position parallel or substantially parallel to the planar horizontal surface 1000. Examples of a planar or substantially planar horizontal surface 1000 (hereafter “assembly support surface 1000”) may include, but are not limited to the ground or earth, an interior floor surface such as an interior warehouse floor and/or the like, an exterior surface such as an exterior warehouse yard surface and/or the like (e.g., a concrete floor, a precast concrete floor, a parking lot or other paved surface, a raised deck or platform type surface, a gravel surface, and combinations thereof).

As shown in FIG. 2, in an embodiment a loading assembly 102 of an assembly 100 may include a raised platform 130 (or “loading platform 130”) including a support surface 132 configured to receive and hold at least one portable load-receiving load-bearing member 20 as shown FIG. 3. In an embodiment, a loading assembly 102 may include a load-transition assembly including a moveable support member (or “moveable cover member 135”) and at least a first stop member (or “loading stop member 138”) configured, in part, to assist in receiving a load or a portion of the load onto a portable load-receiving load-bearing member 20 as described below.

Referring now to FIGS. 3-5, in an embodiment a raised framework 110 of an off-loading assembly 101 may include one or more vertical support members including one or more rearward vertical support members (see rearward vertical support members 124A and 124B), one or more forward vertical support members (see forward vertical support members 124C and 124D) and optionally one or more intermediate vertical support members (see intermediate vertical support members 124E and 124F) extending up from the base member 104 as shown. Other vertical support member configurations are herein contemplated as may be desired or otherwise required in a particular implementation of the assembly 100.

In an embodiment, a raised framework 110 may also include one or more upper elongated non-vertical support members (or “upper support members”) interconnecting the vertical support members 124A-124F. As shown in FIGS. 4 and 5, in an embodiment the upper support members may include one or more rearward upper support members 125A and 125B and one or more forward upper support members 125C and 125D attached to the rearward upper support members 125A and 125B interconnecting vertical supports support members 124A-124F. As shown, in an embodiment the forward vertical support members 124C and 124D may include lengths greater than the lengths of each of the rearward vertical support members 124A and 124B whereby each of the rearward upper support members 125A and 125B extends forward and upward to a point of attachment with the forward upper support members 125C and 125D defining an angle 600 (see FIG. 3) there between as shown. In another embodiment, the rearward vertical support members 124A-124B may include lengths the same or substantially similar as the lengths of the forward vertical support members 124C and 124D whereby the forward upper support members 125C and 125D may extend rearward and attach directly with the vertical support members 124C and 124D at right angles.

In an embodiment, a raised framework 110 may also include one or more cross members interconnecting one or more vertical support members and/or one or more upper support members. For example, in an embodiment a raised framework 110 may include at least a first cross member 126A interconnecting the vertical support members 124A and 124B and the rearward upper support members 125A and 125B at a point of attachment or contact point between the vertical support members 124A and 124B and the rearward upper support members 125A and 125B (see “contact point 127” in FIG. 3). In an embodiment, a raised framework 110 may also include at least a second cross member 126B interconnecting the forward upper support members 125C and 125D (see FIG. 3). In another embodiment, a raised framework 110 may include a second cross member 126B interconnecting the forward upper support members 125C and 125D and the intermediate vertical support members 124E and 124F at a point of attachment or contact between the forward upper support members 125C and 125D and the intermediate vertical support members 124E and 124F.

In an embodiment, the first and second elongated members 105A and 105B and the one or more cross members 106A, 106B and 106C of the base member 104 may be provided as elongated multi-sided members, cylindrical members, or other configurations, and combinations thereof, effective to provide a planar or substantially planar bottom surface 108 of the base member 104 effective to be located on a planar or substantially planar horizontal assembly support surface 1000 in a manner effective to hold the assembly 100 in an upright stable position during operation of the assembly 100. Similarly, the vertical support members 124A-124F, the upper support members 125A-125D and the first and second cross members 126A and 126B may be provided as elongated multi-sided members, cylindrical members, or other configurations, and combinations thereof, effective to provide a structural framework 110 for an off-loading assembly 101 during operation of the assembly 100. In an embodiment, the first and second elongated members 105A and 105B, the one or more cross members 106A, 106B and 106C, the vertical support members 124A-124F, the upper support members 125A-125D and the first and second cross members 126A and 126B may be comprised of one or more elongated rectangular members (e.g., solid rectangular members and/or rectangular tubing).

As stated above, the raised framework 110 may be configured as a structural support for a load-moving system of the assembly 100. Referring to FIG. 2, in an embodiment the vertical support members 124C and 124D of the raised framework 110 may be configured as vertical supports for the off-loading platform 115 of the load-moving system, and the first cross member 126A may function as a horizontal support for the one or more first horizontal linear actuators 120 of the push assembly of a load-moving system as described below. As stated above, the off-loading platform 115 is suitably configured to receive and hold at least one portable load-carrying load-bearing member 15 and may be moved in either direction, operating as a lift-type platform for the portable load-carrying load-bearing member 15. In an embodiment, a rearward portion of the off-loading platform 115 may be configured to be slidably attached to one or both of the vertical support members 124C and 124D. For example, with reference to FIGS. 6 and 10, in an embodiment a rearward portion of the off-loading platform 115 may include one or more vertically disposed U-shaped connectors 140 and 141, wherein U-shaped connector 140 has a front sidewall 140A, a right sidewall 140B and a left sidewall 140C configured to mate with or otherwise cover at least part of the front side surface 128A, the right side surface 128B, and the left side surface 128C of vertical support member 124C, and wherein the U-shaped connector 141 has a front sidewall 141A, a right sidewall 141B and a left sidewall 141C configured to mate with or otherwise cover at least part of the front side surface 129A, the right side surface 129B, and the left side surface 129C of vertical support 124D. As shown in FIG. 6, the right sidewall 140B and the left sidewall 140C may form right angles with the front sidewall 140A, and the right sidewall 141B and the left sidewall 141C may form right angles with the front sidewall 141A. In another embodiment, one or more of the U-shaped connectors 140 and 141 may include one or more parabolic shapes effective for use with one or more of the vertical support members 124C and 124D.

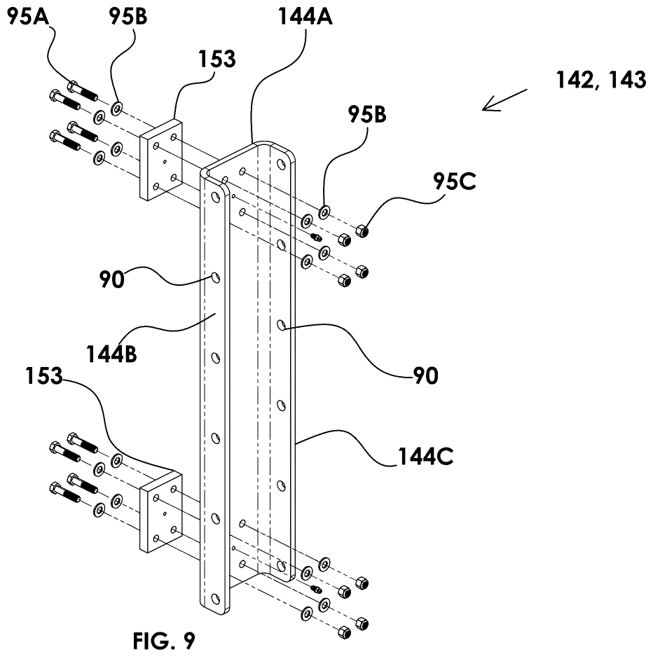

With reference to FIG. 9, the off-loading platform 115 may also include one or more rear cover plates 142 and 143 releasably attachable to the U-shaped connectors 140 and 141 in a manner effective to cover the rear surfaces 128D and 129D of the vertical support members 124C and 124D, wherein the rear cover plates 142 and 143 and the U-shaped connectors 140 and 141 may cooperate to form sleeve-type connector assemblies (or “sleeves”) of the off-loading platform 115 slidable in either direction along the vertical support members 124C and 124D. As depicted, in an embodiment each rear cover plate 142 and 143 may include an elongated C-shaped member having a planar or substantially planar front sidewall 144A and opposing sidewalls 144B and 144C, the sidewalls 144B and 144C comprising one or more apertures 90 configured to align with corresponding one or more apertures 91 disposed along the right sidewall 140B and the left sidewall 140C of U-shaped connector 140 and along the right sidewall 141B and the left sidewall 141C of U-shaped connector 141 (see FIGS. 6 and 10). In an embodiment, when assembled, the front sidewall 144A of the cover plates 142 and 143 may form right angles with the right and left sidewalls 140B and 140C of U-shaped connector 140 and with right and left sidewalls 141B and 141C of U-shaped connector 141.

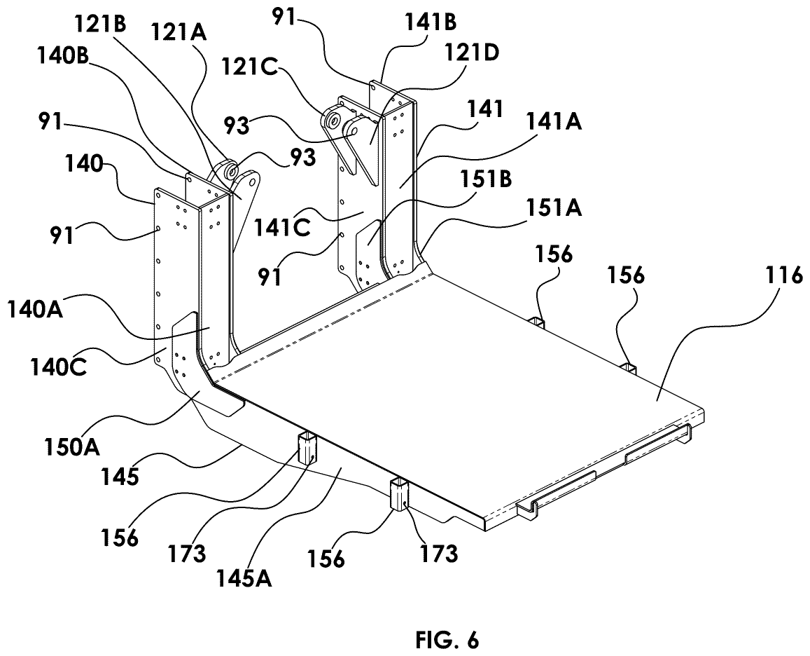

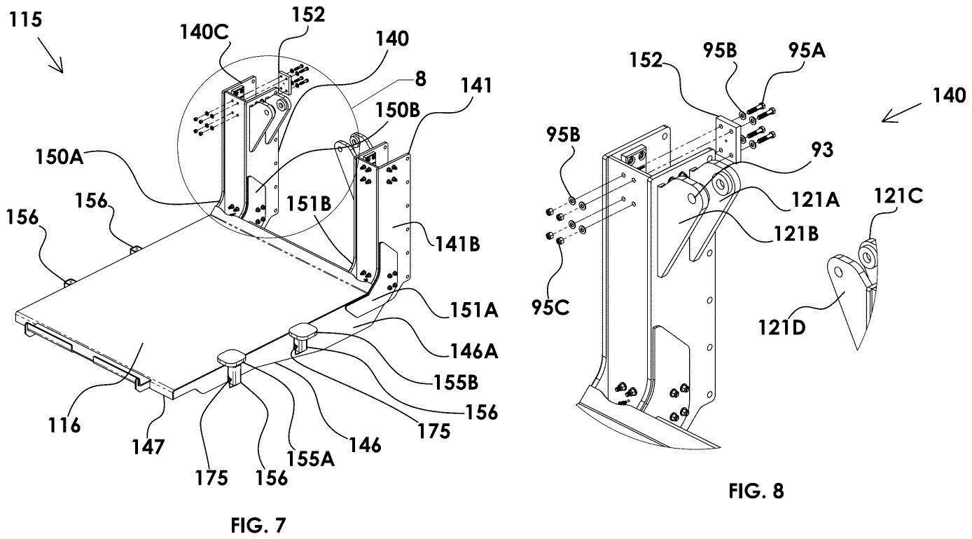

In an embodiment, to promote vertical travel of the sleeves along the vertical support members 124C and 124D each sleeve may have inner dimensions slightly greater than the outer dimensions of the vertical support members 124C and 124D providing space there between effective to reduce sliding friction and to receive one or more wear protection members such as wear pads (also referred to as “slide pads”) and/or the like. In an embodiment, each sleeve may include one or more front wear pads 152 (see FIGS. 7 and 8) disposed between (1) the front sidewall 140A of U-shaped connector 140 and the front side surface 128A of vertical support member 124C and between (2) the front sidewall 141A of U-shaped connector 141 and the front side surface 129A of vertical support member 124D (see FIG. 8). In an embodiment, each sleeve may include one or more rear wear pads 153 disposed between (1) the rear cover plate 142 and the rear surface 128D of vertical support member 124C and/or between (2) the rear cover plate 143 and the rear surface 129D of vertical support member 124D (see FIG. 9). As further shown in FIGS. 8 and 9, the front wear pads 152 and rear wear pads 153 may be removably attached to the front sidewalls 140A and 141A and to the rear cover plates 142 and 143 via one or more fasteners effective for removal and replacement of worn front and rear wear pads 152 and 153 with other wear pads 152 and 153 as needed. Suitable wear pad fasteners may include, but are not limited to one or more threaded fasteners and/or one or more threaded fastener assemblies (e.g., one or more threaded fasteners 95A, washers 95B and hex nuts 95C).

Although the U-shaped connectors 140 and 141 and the rear cover plates 142 and 143 are depicted as solid members enclosing portions of the vertical support members 124C and 124D, in another embodiment the U-shaped connectors 140 and 141 and/or the rear cover plates 142 and 143 may be provided in a different configuration effective for use as described herein (e.g., provided as perforated members and/or provided as frame type members to minimize material usage).

In an embodiment, a rearward portion of the off-loading platform 115 may include one or more wheeled trolleys configured to move the off-loading platform 115 vertically in either direction along the vertical support members 124C and 124D. In another embodiment, a rearward portion of the off-loading platform 115 may include one or more sleeve-type connectors with one or more inner surfaces equipped with one or more low-profile roller ball bearings and/or cylindrical rollers configured to contact one or both of the vertical support members 124C and 124D to facilitate vertical travel of the sleeve-type connectors in either direction.

Referring to FIGS. 6 and 7, in an embodiment the off-loading platform 115 may include (1) two opposing frame members 145 and 146 (or “first and second frame members 145 and 146” or “outer side plates 145 and 146”) having outer surfaces 145A and 146A defining the left and right sides of the off-loading platform 115 and (2) a horizontal support plate 147 supported on the frame members 145 and 146, the support plate 147 having a width the same or substantially the same as the distance from the outer surface 145A of frame member 145 to the outer surface 146A of frame member 146 as shown. In an embodiment, the support plate 147 may rest on the frame members 145 and 146 during operation. In an embodiment, the support plate 147 may be removably attached to one or both of the frame members 145 and 146 (e.g., via one or more fasteners, via one or more clamps, via one or more ties, and combinations thereof). Depending on the materials of construction, in an embodiment, the support plate 147 may be permanently attached to one or both of the frame members 145 and 146 (e.g., via one or more welds, via one or more adhesives). In an embodiment, the support plate 147 and frame members 145 and 146 may be provided as a one-piece construction. In an embodiment, the off-loading platform 115 may also include one or more gussets and/or the like (not shown) (e.g., angle iron and/or the like), disposed below the support plate 147 and interconnecting the frame members 145 and 146 in a manner effective to add structural support to the off-loading platform 115.

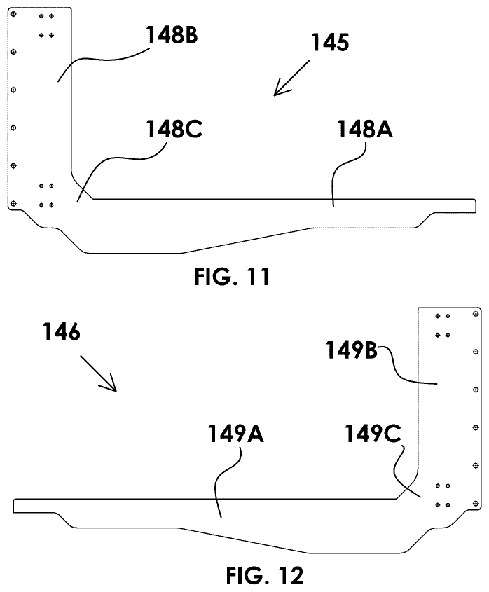

Referring to FIGS. 11 and 12, in an embodiment each of the frame members 145 and 146 may include a horizontal arm 148A and 149A, a vertical arm 148B and 149B and an elbow 148C and 149C, whereby the vertical arm 148B of frame member 145 may be configured as the left sidewall 140C of U-shaped connector 140 and the vertical arm 149B of frame member 146 may be configured as the right sidewall 141B of U-shaped connector 141 (see FIGS. 6 and 7). As further shown in FIGS. 6 and 7, the off-loading platform 115 may include one or more structural reinforcement members for one or more of the U-shaped connectors 140 and 141. In an embodiment, structural reinforcement members may include, but are not limited to one or more doubler plates 150A and/or 151A attached at the elbows 148C and 149C of the frame members 145 and 146 and/or one or more opposing doubler plates 150B attached to the right sidewall 140B of U-shaped connector 140 and/or one or more doubler plates and 151B attached to the left sidewall 141C of U-shaped connector 141. Depending on the materials of construction, in an embodiment, the one or more doubler plates 150A, 150B, 151A, 151B may be removably attached to the frame members 145 and 146 and the U-shaped connectors 140 and 141. In an embodiment, the one or more doubler plates 150A, 150B, 151A, 151B may be permanently attached to the frame members 145 and 146 and the U-shaped connectors 140 and 141 (e.g., via welds, via one or more adhesives).

In an embodiment, the off-loading platform 115 may further include one or more raised stop surfaces at a side of the support plate 147 and/or on top of the support plate 147 of the off-loading platform 115, wherein the one or more raised stop surfaces are configured as one or more abutment surfaces for a portable load-carrying load-bearing member 15 as the portable load-carrying load-bearing member 15 is being placed onto the support plate 147 (see stop members 155A and 155B in FIG. 7). For example, in an embodiment a portable load-carrying load-bearing member 15 may be placed onto the support plate 147 manually or via lifting equipment such as a forklift and/or the like from either side of the assembly 100 (see directional arrows A1 and A2 in FIG. 5). As such, depending on the side of the assembly 100 from which a portable load-carrying load-bearing member 15 is being directed onto the off-loading platform 115 (herein referred to as an “operating side” of an assembly 100), one or more stop members 155A and 155B may be located on or near a non-operating side of the assembly 100 in a manner effective to (1) prevent a portable load-carrying load-bearing member 15 from being directed off the support plate 147 onto the non-operating side of the assembly 100 as the portable load-carrying load-bearing member 15 is being placed onto the support plate 147 and (2) position a portable load-carrying load-bearing member 15 on the support plate 147 at a desired location (e.g., a centered position or a substantially centered position) atop the support plate 147 centrally aligned with or substantially centrally aligned with the longitudinal centerline C1 of the assembly 100 (see the portable load-carrying load-bearing member 15 located on top of support plate 147 in FIG. 3). As such, the assembly 100 is configured to operably position a portable load-carrying load-bearing member 15 on the off-loading assembly 101 effective for operable transfer of a load and/or a portion of the load off of the portable load-carrying load-bearing member 15 onto the loading assembly 102 of the assembly 100. Herein, the one or more stop members 155A and 155B may also be referred to as one or more “off-loading platform stop members 155A and 155B.”

In an embodiment, the assembly 100 may include one or more attachment surfaces on or near each side of the off-loading platform 115 configured to receive and hold one or more removable stop members 155A and 155B according to an intended or designated operating side of the assembly 100. As shown in FIG. 6, in an embodiment, the assembly 100 may include one or more female-type mating members including, but not limited to, vertically or substantially vertically disposed four-sided pocket type members (or “pockets 156”) and/or the like on each side of the off-loading platform 115 for receiving the one or more stop members 155A and 155B in a mated position on a non-operating side of the assembly 100. In an embodiment, the one or more stop members 155A and 155B may be removably mated with the pockets 156 and held in an operable position(s) via gravitational force and/or via one or more removable fasteners as described below-see the one or more stop members 155A and 155B mated with the one or more pockets 156 attached to the outer surface 146A of frame member 146 on a right side of the assembly 100 in FIG. 7 whereby the left side of the assembly 100 is the operating side.

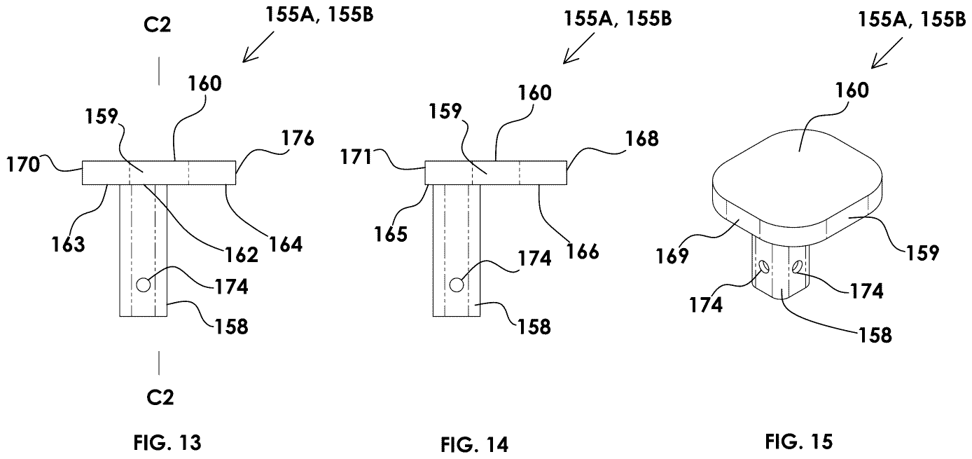

In an embodiment, the one or stop members 155A and 155B of FIG. 7 may comprise a configuration as shown in FIGS. 13-15 . In such an embodiment, each of the one or more stop members 155A and 155B may include a lower elongated male-type member 158 configured to mate with one or more pockets 156 as shown in FIG. 7. Each of the one or more stop members 155A and 155B may also include an upper member 159 comprising one or more abutment surfaces for a portable load-carrying load-bearing member 15. As shown, in an embodiment, an upper member 159 may include rectangular disc-type member having a planar horizontal main body 160 configured as one or more abutment surfaces for a portable load-carrying load-bearing member 15 as determined according to the orientation of the one or more stop members 155A and 155B when mated with the one or more pockets 156. In operation, in an embodiment the one or more stop members 155A and 155B may each have a height the same or substantially similar to a height of a portable load-carrying load-bearing member 15 to be located on the off-loading platform 115. In an embodiment, the one or more stop members 155A and 155B may each have a height of or about thirty (30.0) percent of a tallest portable load-carrying load-bearing member 15 to be located on the off-loading platform 115.

In an embodiment, a male-type member 158 may extend out from a bottom surface 162 of an upper member 159 at a central position along the bottom surface 162 (i.e., whereby the male-type member 158 is centrally aligned along a longitudinal centerline C2 of a main body 160). As shown in FIGS. 13-15, in an embodiment, a male-type member 158 may be located at an off-center position (i.e., whereby the male-type member 158 extends out from a bottom surface 162 of an upper member 159 offset from the longitudinal centerline C2 of a main body 160). As seen in the front view of stop members 155A and 155B in FIG. 13, an off-set male-type member 158 divides the main body 160 into a first part 163 located left of the male-type member 158 and a second part 164 located right of the male-type member 158 wherein the first part 163 of the main body 160 has a length less than a length of the second part 164 of the main body 160. As seen in the right side view in FIG. 14, the off-set male-type member 158 divides the main body 160 into a third part 165 located left of the male-type member 158 and a fourth part 166 located right of the male-type member 158 wherein the third part 165 of the main body 160 has a length less than a length of the fourth part 166 of the main body 160. Suitably, one or more stop members 155A and 155B as shown in FIGS. 13-15 may be configured as one or more adjustable stop members providing multiple stop positions for a portable load-carrying load-bearing member 15 according to the orientation of the one or more stop members 155A and 155B when mated with the one or more pockets 156. For example, referring to stop member 155A in FIG. 7, when a stop member 155A is mated with a pocket 156 with a left side of the stop member 155A facing the forward part of the assembly 100 then the fourth part 166 of the main body 160 suitably extends out from the male-type member 158 and over the support surface 116 a distance whereby an outer surface 168 of the upper member 159 acts as an abutment surface (or “first contact surface”) for a portable load-carrying load-bearing member 15 of a first width wherein the fourth part 166 of the main body 160 suitably extends over the support surface 116 a distance effective for centering the portable load-carrying load-bearing member 15 as described above. Still referring to FIG. 7, in an embodiment a stop member such as stop member 155A may be rotated ninety (90.0) degrees clockwise and mated with a pocket 156 as depicted by stop member 155B wherein the outer surface 169 of the upper member 159 faces the forward part of the assembly 100. In this orientation, the length of the first part 163 of the main body 160 extends out from the male-type member 158 a distance whereby an outer surface 170 of the shoulder 161A is vertically aligned or substantially vertically aligned with the outer surface 146A of the frame member 146 wherein the outer surface 170 acts as an abutment surface (or “second contact surface”) for a portable load-carrying load-bearing member 15 of a second width effective for centering the portable load-carrying load-bearing member 15 as described above. A stop member 155A as shown in FIG. 7 may be referred to herein as being set in a “first stop position” and a stop member 155B as shown in FIG. 7 may be referred to herein as being set in a “second stop position.”

In an embodiment, a stop member such as stop member 155A as depicted in FIG. 7 may be rotated one-hundred eighty degrees and mated with a pocket 156 with a right side of the stop member 155A facing the forward part of the assembly 100 in a third stop position. In such an embodiment, a third part 165 of the main body 160 suitably extends from the male-type member 158 a distance whereby an outer surface 171 of the upper member 159 is planarly or substantially planarly disposed at a point between the male-type member 158 and a vertical projection plane defined by the outer surface 146A of frame member 146 effective as an abutment surface (or “third contact surface”) for a portable load-carrying load-bearing member 15 of a third width for centering the portable load-carrying load-bearing member 15 as described above. Likewise, in an embodiment a stop member such as stop member 155A as depicted in FIG. 7 may be rotated ninety degrees counter-clockwise and mated with a pocket 156 wherein the outer surface 168 of the upper member 159 faces the forward part of the assembly 100 in a fourth stop position. In this orientation, the length of the second part 164 of the main body 160 suitably extends from the male-type member 158 and over the support surface 116 a distance whereby the outer surface 176 of the upper member 159 acts as an abutment surface (or “fourth contact surface”) for a portable load-carrying load-bearing member 15 of a fourth width wherein the second part 164 of the main body 160 suitably extends over the support surface 116 a distance effective for centering a portable load-carrying load-bearing member 15 as described above.

With further reference to FIGS. 6, 7 and 13-15, in an embodiment, each of the one or more pockets 156 may include one or more apertures 173 and each of the one or more male-type members 158 may include one or more corresponding apertures 174 for receiving a fastener 175 and/or the like there through for holding the one or more stop members 155A and 155B in fixed position(s) during operation. Suitable fasteners 175 may include, but are not limited to, one or more locking pins, one or more threaded fasteners, one or more clips, and combinations thereof. Suitable locking pins may include, but are not limited to, one or more dowel pins, one or more cotter pins, one or more clevis pins, one or more detent pins, and combinations thereof. In an embodiment, the one or more pockets 156 may include open ended members. In an embodiment, the one or more pockets 156 may include closed ends, or otherwise obstructed bottom ends (e.g., a lip and/or the like), disposed along the inner perimeter of the bottom end of the one or more pockets 156), effective as support surfaces for the male-type member 158 of each of the one or more stop members 155A and 155B. In an embodiment, a combination of a pocket 156 and a stop member (e.g., stop member 155A, 155B) may be referred to as a “stop member assembly” of the assembly 100.

Other upper member 159 configurations are herein contemplated. For example, in an embodiment one or more upper members 159 may be provided in one or more solid or hollow block-shape configurations with right angle corners as opposed to rounded corners as shown in FIGS. 13-15 . In an embodiment, one or more upper members 159 may be provided in one or more solid or hollow circular disc-shape configurations. In an embodiment, one or more upper members 159 may be provided in one or more solid or hollow sphere-type configurations. In an embodiment, one or more upper members 159 may be provided in one or more bollard-type configurations. In an embodiment, one or more upper members 159 may be provided in one or more irregular-shape configurations. Also, although a male-type member 158 is shown as a four-sided member in FIGS. 13-15 for mating with a four-sided pocket 156, in an embodiment a male-type member 158 and corresponding pocket 156 may include a different multi-side configuration. In another embodiment, a male-type member 158 and a corresponding pocket 156 may be provided as cylindrical members comprising a plurality of corresponding apertures 173, 174 whereby an upper member 159 may be turned three-hundred sixty (360.0) degrees for orienting the upper member 159 in a desired stop position. As will be appreciated, in an embodiment any one stop member 155A, 155B may include a plurality of stop positions according to (1) the size and shape of the upper member 159, (2) the configuration and location of a male-type member 158 in relation to the upper member 159, and (3) the number and location of apertures 174 relative to the upper member 159.

In another embodiment, a support surface 116 of an off-loading platform 115 may include one or more apertures for receiving one or more elongated stop members (e.g., one or more bollard-type stop members in releasable attachment with one or more threaded apertures), each configured to receive a threaded outer surface of an elongated stop member. In another embodiment, one or more vertically disposed planar wall-type abutment surfaces may be releasably attachable to the support surface 116 and/or releasably attachable to outer side plates 145 and 146 of the off-loading platform 115.

As described herein, in an embodiment, the one or more first vertical linear actuators 118A and 118B of the adjustable platform assembly are configured to direct the off-loading platform 115 vertically in either direction along the vertical support members 124C and 124D to a plurality of set positions suitable for off-loading one or more loads and/or one or more portions of loads onto the loading assembly 102 of the assembly 100 or onto one or more portable load-receiving load-bearing members 20 located on the loading assembly 102 as described below. An adjustable platform assembly of this disclosure is not limited to any one configuration, but suitably includes a configuration effective as a lift-type platform for at least one portable load-carrying load-bearing member 15 as described above.

Referring to FIG. 10, in an embodiment, the first vertical linear actuator 118A may be operably communicated with U-shaped connector 140, and the first vertical linear actuator 118B may be operably communicated with U-shaped connector 141. With reference to FIGS. 5 and 10, in an embodiment, the first vertical linear actuator 118A may include (1) a first end attached to one or more attachment surfaces 119A and 119B (or “mounting surfaces 119A and 119B”) located on the second cross member 106B and (2) a second end attached to one or more attachment surfaces 121A and 121B (or “mounting surfaces 121A and 121B”) located on the U-shaped connector 140. Likewise, the first vertical linear actuator 118B may include (1) a first end attached to one or more attachment surfaces 119C and 119D (or “mounting surfaces 119C and 119D”) located on the second cross member 106B and (2) a second end attached to one or more attachment surfaces 121C and 121D (or “mounting surfaces 121C and 121D”) located on the U-shaped connector 141. As shown, in an embodiment the second cross member 106B may be disposed in line with the vertical support members 124C and 124D, providing for attachment surfaces 119A and 119B and attachment surfaces 121A and 121B to be vertically aligned with attachment surfaces 119C and 119D and attachment surfaces 121C and 121D, thereby securing the first vertical linear actuators 118A and 118B in vertical positions in line with the travel paths of the U-shaped connectors 140 and 141 and ensuring that the first vertical linear actuators 118A and 118B travel at the same rate during operation.

In an embodiment, each of the one or more first vertical linear actuators 118A and 118B may include a double-acting hydraulic cylinder wherein a bore at a tail end 123A of each double-acting hydraulic cylinder 118A and 118B is attached to opposing mounting surfaces 119A, 119B and 119C, 119D (see double-acting hydraulic cylinder 118B in FIG. 10) and a distal end 123B of a drive rod of each of the one or more first vertical linear actuators 118A and 118B is attached to one or more attachment surfaces 121A, 121B and 121C and 121D. Without limiting the disclosure, suitable attachment surfaces 119A-119D and 121A 121D may be provided as planar-type projections with apertures there through (see apertures 92 and 93 in FIGS. 6 and 10). In one suitable embodiment, each double acting hydraulic cylinder 118A and 118B may be attached to attachment surfaces 119A-119D and 121A-121D via fasteners such as pins, socket head screws, flange bolts and flange nuts, hex bolts and hex nuts, and clips (e.g., spring clips or other clips). In another embodiment, the one or more first vertical linear actuators 118A and 118B may be provided as one or more pneumatic cylinders along with at least one pneumatic power supply of the assembly 100. In another embodiment, the one or more first vertical linear actuators 118A and 118B may be provided as mechanical actuators (e.g., screw jacks), along with at least one electric power source of the assembly 100.

In an embodiment, each of the sleeves described above may be directed vertically a maximum distance in either direction according to the length of the vertical support members 124C and 124D, the length of each sleeve, the size and/or type of the first vertical linear actuators 118A and 118B (e.g., a stroke length), and combinations thereof. Although an assembly 100 of this disclosure may be built to scale, for purposes of moving building materials including, but not limited to bundles of roof shingles 10, an adjustable platform assembly may be configured to operably move vertically and hold up to or about 2494.8 kg total (5500.0 pounds total) per load.

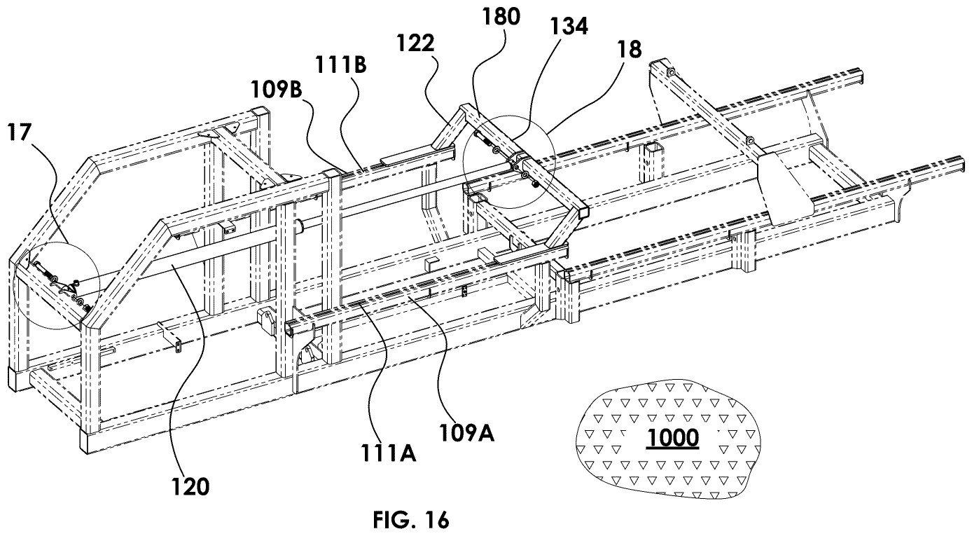

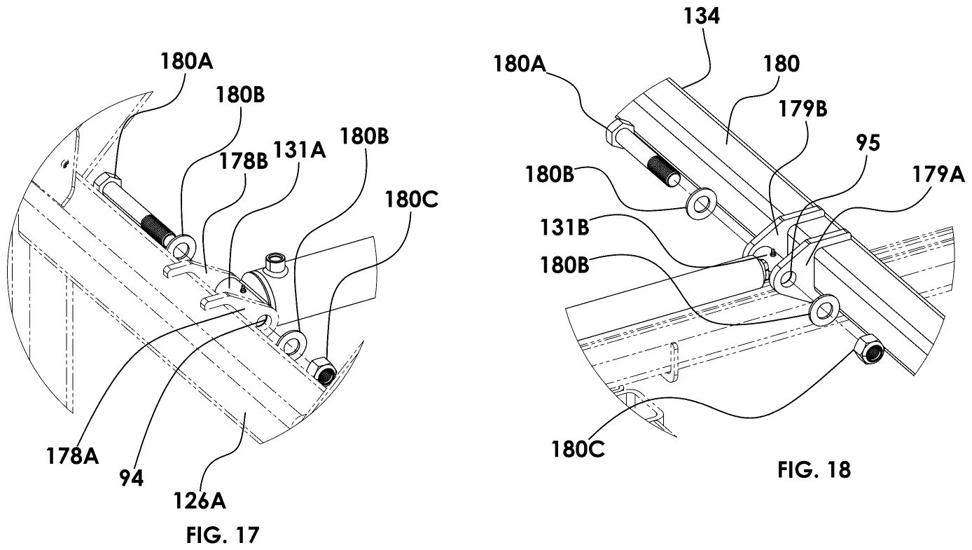

Referring to FIGS. 16-18, in an embodiment, the one or more first horizontal linear actuators 120 of the push assembly may include one or more double-acting hydraulic cylinders 120 wherein a bore at a tail end 131A of the double-acting hydraulic cylinder 120 may be attached to one or more attachment surfaces 178A and 178B (or “mounting surfaces 178A and 178B”) located on a first cross member 126A of a raised framework 110 and a distal end 131B of a drive rod of the double-acting hydraulic cylinder 120 may be attached to one or more attachment surfaces 179A and 179B (or “mounting surfaces 179A and 179B”) on a rear side of a push bar 180 of the push member 122. Without limiting the disclosure, suitable attachment surfaces 178A, 178B, 179A, 179B may be provided as planar-type projections with apertures there through (see apertures 94 and 95). In an embodiment, a double-acting hydraulic cylinder 120 may be attached to attachment surfaces 178A, 178B, 179A, 179B via fasteners such as pins, socket head screws, flange bolts and flange nuts, hex bolts and hex nuts, and clips (e.g., spring clips or other clips) (see hex bolts 180A, washers 180B, and hex nuts 180C in FIGS. 17 and 18). In another embodiment, the one or more first horizontal linear actuators 120 may be provided as one or more pneumatic cylinders. In another embodiment, the one or more first horizontal linear actuators 120 may be provided as one or more mechanical actuators (e.g., one or more screw jacks).

In an embodiment, the attachment surfaces 178A and 178B may be centrally located on the first cross member 126A as shown and the attachment surfaces 179A and 179B may be centrally located on the rear side of the push bar 180 of the push member 122 as shown effective for securing the one or more first horizontal linear actuators 120 in line along the longitudinal centerline C1 of the assembly 100 parallel or substantially parallel to a planar horizontal surface 1000 to prevent or otherwise minimize any horizontal side-loading of the one or more first horizontal linear actuators 120 during operation.

Referring to FIG. 16, in an embodiment, the push bar 180 of the push member 122 may include a linear member disposed perpendicular or substantially perpendicular to (1) the one or more first horizontal linear actuators 120 and (2) the longitudinal centerline C1 of the assembly 100, the push bar 180 having a planar or substantially planar front surface 134 configured as an abutment surface for a load placed on the off-loading platform 115 of the assembly 100. As shown, in an embodiment, the front surface 134 of the push bar 180 may include a length at least the same or substantially the same as the width of the support surface 116 of the off-loading platform 115 effective to provide an abutment surface across a width of a load or a portion of a load, or across a majority of a width of a load or a portion of a load located on the support surface 116. In an embodiment, the push bar 180 may include elongated rectangular tubing as shown in FIG. 16. In an embodiment, the push bar 180 may include a different multi-sided configuration having a front surface 134. In another embodiment, the push bar 180 may include a configuration including one or more front surfaces effective for directing a load and/or a portion of a load off of or from the off-loading assembly 101 onto the loading assembly 102 as described herein. In an embodiment, the push bar 180 may include a solid rectangular member. In an embodiment, the front surface 134 may include a non-planar surface.

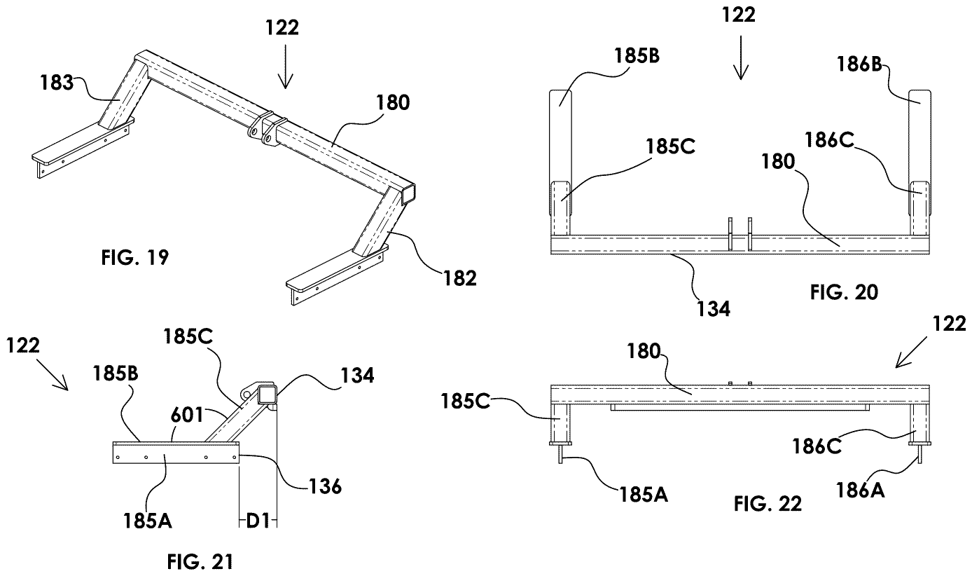

Referring to FIGS. 19-23, in an embodiment, the push member 122 may comprise opposing support members 182 and 183 slidably communicated with the one or more guide rails 109A and 109B and configured to orient a corresponding push bar 180 in a horizontal or substantially horizontal position relative to the assembly support surface 1000 at a vertical position above the assembly support surface 1000 that is the same or substantially the same as the vertical position of the first cross member 126A, thereby providing a horizontally or substantially horizontally disposed one or more first horizontal linear actuators 120 relative to the assembly support surface 1000 to prevent or otherwise minimize any vertical side-loading of the one or more first horizontal linear actuators 120 during operation. In the embodiment as shown, each support member 182 and 183 includes a slidable member 185A and 186A configured to travel along a corresponding guide rail 109A and 109B in either direction. In an embodiment, the guide rails 109A and 109B may include upper linear guide channels 111A and 111B (see FIG. 5) comprising elongated slots of a constant or substantially constant width, and each of the slidable members 185A and 186A may include a vertically disposed planar slide plate and/or the like configured to slidably mate with the upper guide channels 111A and 111B. In an embodiment, each of the guide channels 111A and 111B may comprise a length up to or about a length of each of the guide rails 109A and 109B and each of the slidable members 185A and 186A may be slidably constrained within the corresponding guide channels 111A and 111B during operation, while still allowing for the push member 122 to be removed from the guide rails 109A and 109B by directing the push member 122 upward vertically apart from the guide rails 109A and 109B. As shown in FIG. 4, in an embodiment, the guide rails 109A and 109B may be provided as rectangular tubing and/or the like with guide channels 111A and 111B disposed along an upper surface of each of the guide rails 109A and 109B for receiving the slidable members 185A and 186A therein. In an embodiment, the guide rails 109A and 109B may include one or more other multi-sided configurations. In an embodiment, the guide rails 109A and 109B may be provided as cylindrical tubular members with guide channels 111A and 111B disposed along an uppermost point of each of the cylindrical tubular members. Herein, the guide rails 109A and 109B may also be referred to as “off-loading guide rails 109A and 109B.”

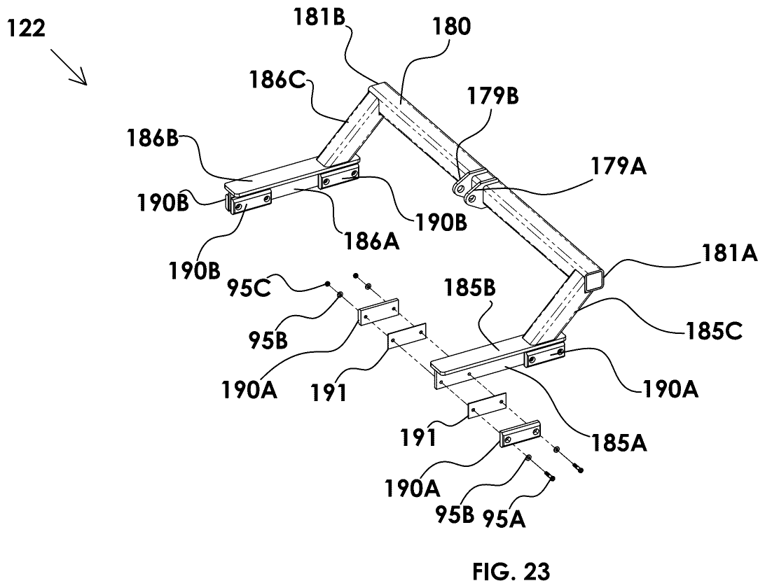

With reference to FIG. 23, in an embodiment, each of the slidable members 185A and 186A may include one or more wear pads 190A and 190B similar to those described above and located on one or both sides of the slidable members 185A and 186A as shown. In an embodiment, one or more shims 191 and/or the like may be used between the slidable members 185A and 186A and the wear pads 190A and 190B as shown. Similar as described above, suitable wear pad fasteners for the one or more wear pads 190A and 190B may include, but are not limited to one or more threaded fasteners and/or one or more threaded fastener assemblies (e.g., one or more threaded fasteners 95A, washers 95B and hex nuts 95C). As will be appreciated, each of the guide channels 111A and 111B of the guide rails 109A and 109B may have a width selected as required for suitable operation of the slidable members 185A and 186A. For example, in an embodiment, each of the guide channels 111A and 111B may have a width configured to receive the slidable members 185A and 186A equipped with one or more wear pads 190A and 190B and one or more shims 191 therein.

In an embodiment, each of the slidable members 185A and 186A may include a mounting member 185B and 186B providing a mounting surface for elongated support members 185C and 186C that interconnect the slidable members 185A and 186A with the push bar 180. In an embodiment, distal ends of the elongated support members 185C and 186C may be attached at or near the distal ends 181A and 181B of the push bar 180 at points located on each side of the assembly 100 (see FIG. 23). In an embodiment, the elongated support members 185C and 186C may include multi-sided members as shown in FIGS. 19-23 (e.g., rectangular tubing or solid rectangular members), or, one or more other configurations operable as interconnecting members such as cylindrical tubing and/or the like.

With particular reference to FIG. 21, in an embodiment, each of the elongated support members 185C and 186C extends forward and upward to a point of attachment with the push bar 180, defining an angle 601 with the mounting members 185B and 186B, whereby the push bar 180 is located at a point forward of the slidable members 185A and 186A and the mounting members 185B and 186B. As shown in FIG. 2, the one or more first horizontal linear actuators 120 suitably include a stroke length effective to direct the push bar 180 to a position forward of the off-loading platform 115 and over the loading platform 130 of the loading assembly 102. Although an assembly 100 of this disclosure may be built to scale, for purposes of moving building materials including, but not limited to bundles of roof shingles 10, a front surface 134 of the push bar 180 may be located at a point of or about 15.24 cm (6.0 inches) forward of a front surface 136 of the slidable members 185A and 186A (see distance D1 in FIG. 21).

In an embodiment, the guide rails 109A and 109B are disposed to each side of the off-loading platform 115 of the assembly 100 whereby the push bar 180 includes a length such that the distal ends 181A and 181B of the push bar 180 terminate at points located out beyond the frame members 145 and 146 of the off-loading platform 115, ensuring that the front surface 134 of the push bar 180 is configured to contact a load or a portion of a load located on the support surface 116 (see FIG. 2). In an embodiment, each of the guide rails 109A and 109B may be attached to the main frame 103. For example, guide rail 109A may include one or more support members 188A attached to the intermediate vertical support member 124E and one or more support members 188B attached to the first elongated member 105A of the base member 104, and guide rail 109B may include one or more support members 189A attached to the intermediate vertical support member 124F and one or more support members 189B attached to the second elongated member 105B of the base member 104 (see FIGS. 4 and 5). As shown, in an embodiment, each of the guide rails 109A and 109B may be disposed at a vertical position above the assembly support surface 1000 effective for locating the push bar 180 at a vertical position the same or substantially the same as the vertical position of the first cross member 126A as described above. As shown in FIG. 5, in an embodiment, the guide rails 109A and 109B may define the width of the assembly 100.

In another embodiment, the support members 182 and 183 may include slidable collar-type members slidably communicated with the guide rails 109A and 109B. In an embodiment, one or more wear pads as described in this disclosure may be disposed between the collar-type support members 182 and 183 and the guide rails 109A and 109B. In another embodiment, the support members 182 and 183 may include one or more low-profile roller ball bearings and/or cylindrical rollers, and the guide rails 109A and 109B may include surfaces configured to receive the one or more low-profile roller ball bearings and/or cylindrical rollers for travel of the support members 182 and 183 along the guide rails 109A and 109B in either direction.

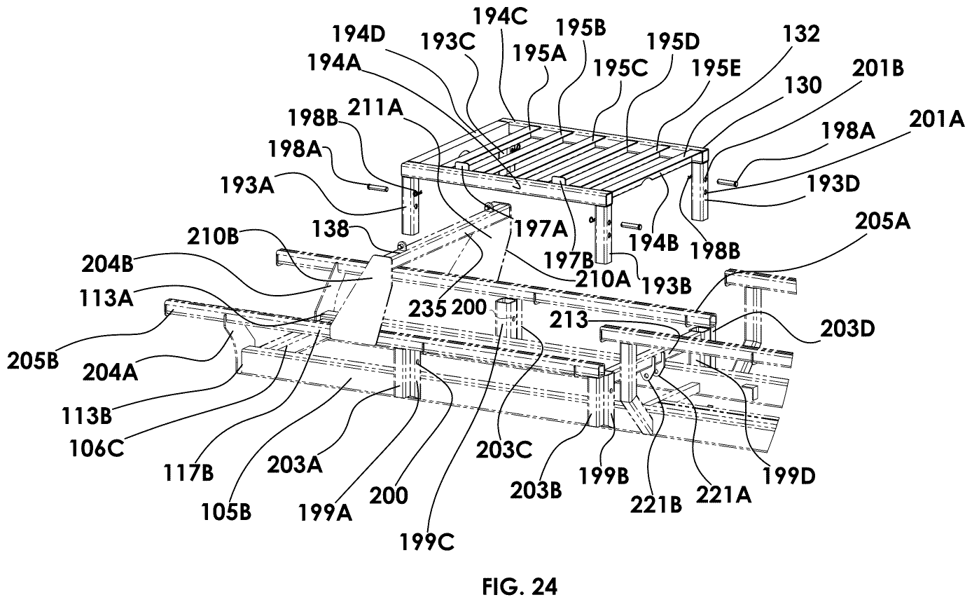

Referring to FIG. 24, in an embodiment, the loading platform 130 may include a planar or substantially planar horizontal upper support surface 132 and a plurality of supports 193A, 193B, 193C, and 193D configured to space the support surface 132 apart from the assembly support surface 1000. In an embodiment, the loading platform 130 may include an assembled framework comprising a plurality of elongated frame members defining the perimeter of the support surface 132 (e.g., see four frame members 194A, 194B, 194C, and 194D defining the sides of a rectangular support surface 132). As shown, the loading platform 130 may include one or more parallel rail members 195A, 195B, 195C, 195D, and 195E disposed between the opposing frame members 194A and 194C, or, in another embodiment, disposed between the opposing frame members 194B and 194D. As shown, in an embodiment, the upper surfaces of the frame members 194A, 194B, 194C, and 194D and the rail members 195A, 195B, 195C, 195D, and 195E are configured as the support surface 132 of the loading platform 130. In an embodiment, the frame members 194A, 194B, 194C, and 194D and the rail members 195A, 195B, 195C, 195D, and 195E may be set in an equidistant spaced-apart relation as shown in FIG. 24. In an embodiment, the frame members 194A, 194B, 194C, and 194D and the rail members 195A, 195B, 195C, 195D, and 195E may be set in a non-equidistant arrangement. In an embodiment, the frame members 194A, 194B, 194C, and 194D and the rail members 195A, 195B, 195C, 195D, and 195E may include elongated rectangular members and/or the like, elongated angle-iron members and/or the like, and combinations thereof. For example, as shown in FIG. 24 in an embodiment, the opposing frame members 194A and 194C defining the left and right sides of the support surface 132, and frame member 194D defining the front side of the support surface 132, may include rectangular tubing, and frame member 194B defining the back side of the support surface 132 may include angle iron similar as the rail members 195A, 195B, 195C, 195D, and 195E. In an embodiment, the frame member 194D defining the front side of the support surface 132 and the frame member 194B defining the back side of the support surface 132 may be considered rail members of the loading platform 130, which includes rail members 195A, 195B, 195C, 195D, and 195E disposed between opposing frame members 194A and 194C as shown.

Still referring to FIG. 24, in an embodiment, the loading platform 130 may include one or more raised stop surfaces including, but not limited to, one or more stop members 197A and 197B (or “loading platform stop members 197A and 197B”) extending upward from the support surface 132 on or near a non-operating side of the assembly 100 as one or more abutment surfaces for at least one portable load-receiving load-bearing member 20. In an embodiment, the one or more stop members 197A and 197B are configured to (1) prevent the portable load-receiving load-bearing member 20 from being directed off the support surface 132 onto the non-operating side of the assembly 100 as the portable load-receiving load-bearing member 20 is being placed onto the support surface 132, and (2) position the portable load-receiving load-bearing member 20 on the support surface 132 at a desired location (e.g., a centered position or a substantially centered position) atop the support surface 132 that is centrally aligned or substantially centrally aligned with the longitudinal centerline C1 of the assembly 100 (see FIG. 3). In the embodiment of FIG. 24, the one or more stop members 197A and 197B may be provided as fixed rectangular planar members having planar abutment surfaces extending vertically upward from the frame member 194A. In another embodiment, one or more stop members 197A and 197B may be provided as raised cylindrical members or other configuration(s) effective to stop the portable load-receiving load-bearing member 20. In an embodiment, the one or more stop members 197A and 197B may be provided as removable members and/or adjustable members similar as the off-loading platform stop members 155A and 155B described above. In an embodiment, the one or more stop members 197A and 197B may each have a height the same or substantially the same as a height of at least one portable load-receiving load-bearing member 20 to be located on the support surface 132. In an embodiment, the one or more stop members 197A and 197B may each have a height of or about thirty (30.0) percent of a height of a tallest portable load-receiving load-bearing member 20 to be located on the support surface 132.

In an embodiment, the loading assembly 102 may include one or more vertically disposed female mating members 199A, 199B, 199C, and 199D (see FIG. 24) configured to receive the corresponding vertical supports 193A, 193B, 193C, and 193D in a mated position as shown in FIG. 2. In an embodiment, the loading platform 130 may be placed onto the loading assembly 102 such that the loading platform 130 may rest in an operable assembled position with the female mating members 199A, 199B, 199C, and 199D via gravitational force and/or via one or more removable fasteners. In an embodiment, the female mating members 199A, 199B, 199C, and 199D may include one or more apertures 200 and each of the vertical supports 193A, 193B, 193C, and 193D may include one or more corresponding apertures for receiving a fastener there through in a manner effective to hold the loading platform 130 in a fixed position during operation. As shown in FIG. 24, in an embodiment, each of the vertical supports 193A, 193B, 193C, and 193D may include a first set of apertures 201A configured to hold the loading platform 130 at a first position with the support surface 132 disposed planarly at a first vertical position above the assembly support surface 1000. Each of the vertical supports 193A, 193B, 193C, and 193D may also include a second set of apertures 201B configured to hold loading platform 130 at a second position with the support surface 132 disposed planarly at a second vertical position above the assembly support surface 1000 that is lower than the first vertical position as depicted in FIG. 2. Suitable fasteners may include one or more fasteners as described above (see dowel pin 198A and cotter pin 198B in FIG. 24). In an embodiment, each of the vertical supports 193A, 193B, 193C, and 193D may include a single set of apertures at a point along each of the vertical supports 193A, 193B, 193C, and 193D as desired or as may otherwise be required for a particular assembly 100 operation. In an embodiment, each of the vertical supports 193A, 193B, 193C, and 193D may include three or more sets of apertures at three or more points along each of the vertical supports 193A, 193B, 193C, and 193D as desired or as may otherwise be required for a particular assembly 100 operation.

As shown in FIG. 24, the female mating members 199A, 199B, 199C, and 199D may be located adjacent outer surfaces 112A and 112B (see FIG. 5) of the first and second elongated members 105A and 105B at positions suitable for locating the loading platform 130 adjacent the off-loading platform 115 of the off-loading assembly 101 effective for operable transfer of a load and/or a portion of a load off of or from at least one portable load-carrying load-bearing member 15 located on the off-loading platform 115 onto at least one portable load-receiving load-bearing member 20 located on the loading platform 130. In an embodiment, the female mating members 199A, 199B, 199C, and 199D may be attached to the first and second elongated members 105A and 105B via one or more fasteners, one or more adhesives, one or more welds, one or more ties, one or more clamps, and combinations thereof.

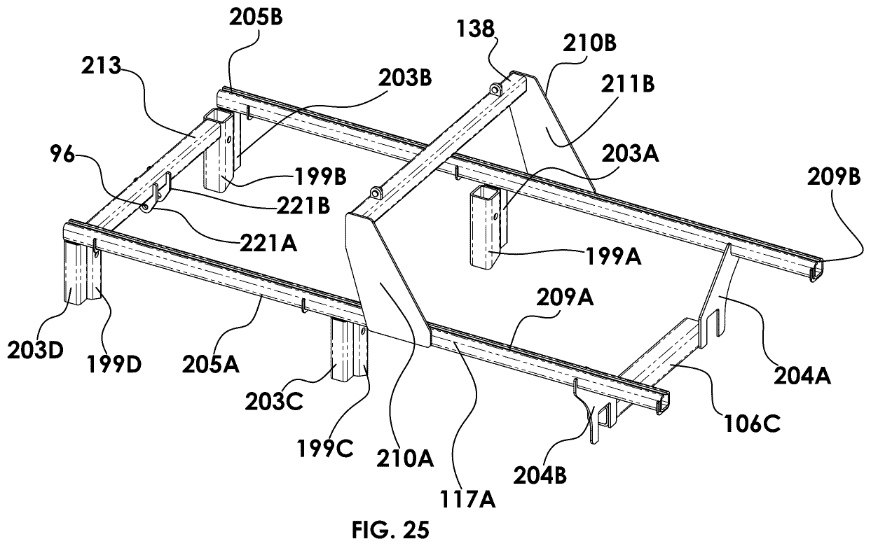

With further reference to FIGS. 24 and 25, in an embodiment, the loading assembly 102 may include a framework comprising one or more vertically disposed support members 203A, 203B, 203C, and 203D located on each side of the loading assembly 102 and configured to support linear guide rails 205A and 205B (or “loading guide rails 205A and 205B”) thereon. In an embodiment, the support members 203A, 203B, 203C, and 203D may be attached to the first and second elongated members 105A and 105B. As shown in the embodiment of FIG. 24, the support members 203A, 203B, 203C, and 203D may be attached to the female mating members 199A, 199B, 199C, and 199D such that loading guide rails 205A and 205B are supported on the uppermost surfaces of the support members 203A, 203B, 203C, and 203D wherein the support members 203A, 203B, 203C, and 203D together with the loading guide rails 205A and 205B define a width of the loading assembly 102 (see FIG. 5).

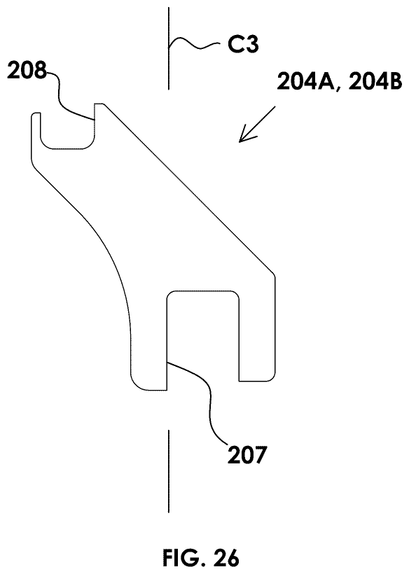

As further shown in FIGS. 24 and 25, in an embodiment, the loading assembly 102 may include one or more vertically disposed support members 204A and 204B located at a forward part of the loading assembly 102 and configured to support forward portions of the loading guide rails 205A and 205B. Although the configuration of the support members 204A and 204B is not limited to any one configuration, in an embodiment, each of the support members 204A and 204B may include a planar member attached to or near the front ends 113A and 113B of the first and second elongated members 105A and 105B (see also FIG. 4). With reference to FIG. 26, in an embodiment, each of the support members 204A and 204B may include a lower mating surface 207 configured to form fit an upper surface and opposing sides of a corresponding first or second elongated member 105A or 105B (see FIG. 24). In an embodiment, each of the support members 204A and 204B may also include an upper mating surface 208 configured to form fit a bottom surface and opposing sides of a corresponding loading guide rail 205A or 205B (see FIG. 24). As such, a size of each of the support members 204A and 204B may be defined by the positions of the first and second elongated members 105A and 105B and the loading guide rails 205A and 205B. As further shown in FIG. 26, in an embodiment the lower mating surface 207 may be offset from the upper mating surface 208 (see longitudinal centerline C3) corresponding to the positions of the first and second elongated members 105A and 105B and the loading guide rails 205A and 205B.

As shown in FIGS. 24 and 25, in an embodiment, the third cross member 106C may interconnect the support members 204A and 204B to provide additional structural integrity to the loading assembly 102. In another embodiment, one or more cross members may also be provided to interconnect (1) the female mating members 199A and 199C and/or (2) the female mating members 199B and 199D.

Referring to FIGS. 24 and 25, in an embodiment, the loading stop member 138 may include a first vertical support member 210A attached to an outer surface 117A of the loading guide rail 205A and a second vertical support member 210B attached to an outer surface 117B of the loading guide rail 205B. In an embodiment, the loading stop member 138 may be attached at or near the uppermost ends of the first and second vertical support members 210A and 210B. In particular, in an embodiment as shown, opposing ends of the loading stop member 138 may be attached to the inner surfaces 211A and 211B of the first and second vertical support members 210A and 210B. Other attachments suitable for operation of the loading stop member 138 are herein contemplated. For example, in an embodiment, the loading stop member 138 may be threadedly connected to the first and second vertical support members 210A and 210B via threaded male members on the distal ends of the loading stop member 138 for mating with threaded apertures on the first and second vertical support members 210A and 210B or vice versa.

Suitably, each of the first and second vertical support members 210A and 210B may be attached at points along the loading guide rails 205A and 205B and extend upward to provide points of attachment for the loading stop member 138 at a vertical position along the loading guide rails 205A and 205B effective for operation of the loading stop member 138 as described below. As shown, in an embodiment, each of the first and second vertical support members 210A and 210B may extend rearward and upward in a manner effective to add structural strength to the loading stop member 138 during operation as described below.

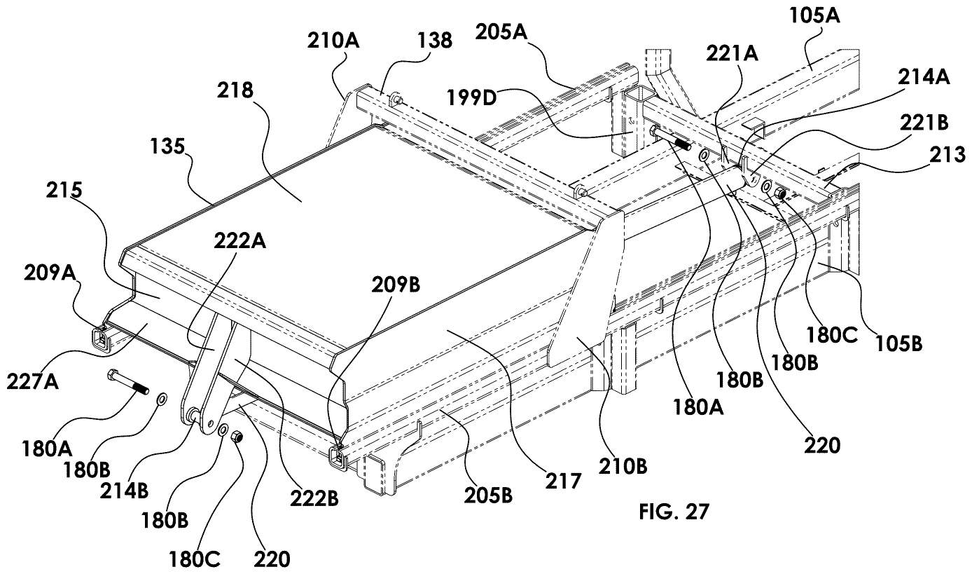

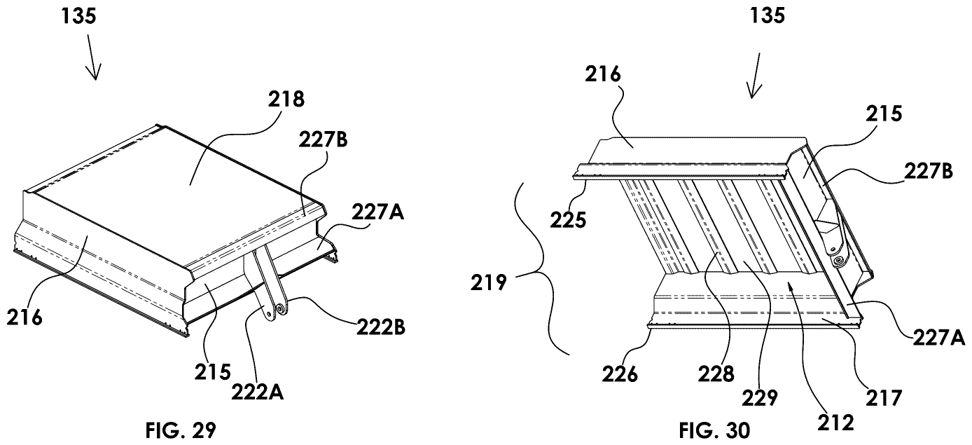

With reference to FIGS. 27-30, the loading assembly 102 may include a moveable cover member 135 configured to be directed along the loading guide rails 205A and 205B in a manner effective to facilitate loading of a load and/or a portion of a load onto at least one portable load-receiving load-bearing member 20 located on the loading platform 130 as described below. In an embodiment, the moveable cover member 135 may be manually directed along the loading guide rails 205A and 205B in either direction. In an embodiment, the moveable cover member 135 (or “loading cover member 135”) may be directed along the loading guide rails 205A and 205B in either direction via one or more second horizontal actuators (e.g., one or more second horizontal linear actuators 220) as described below.

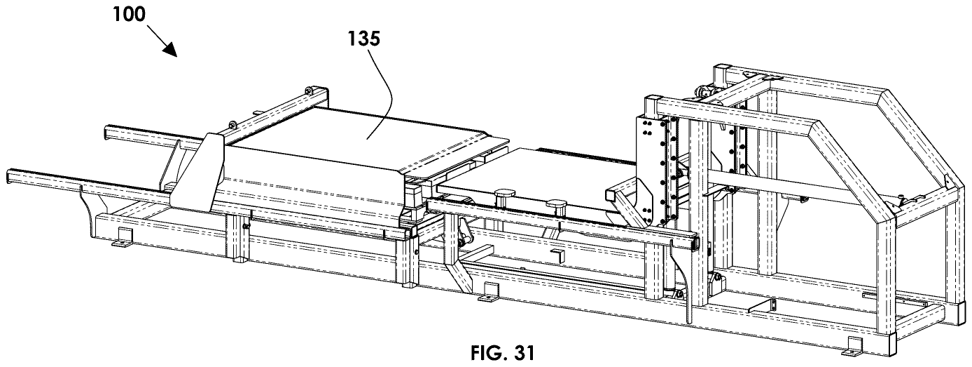

In an embodiment, the moveable cover member 135 may be configured to be directed from a first or non-operating position as shown in FIG. 2 forward of the loading stop member 138 of the assembly 100 to a second or operating position as shown in FIG. 31, rearward of the loading stop member 138 and disposed over the loading platform 130 of the assembly 100. In an embodiment, the moveable cover member 135 may be configured to cover one or more portable load-receiving load-bearing members 20 that are located on the loading platform 130 of the assembly 100 while remaining unobstructed by the one or more portable load-receiving load-bearing members 20. In an embodiment, the moveable cover member 135 may be configured to cover one or more portable load-receiving load-bearing members 20 holding one or more items when the one or more portable load-receiving load-bearing members 20 are located on the loading platform 130 of the assembly 100 while remaining unobstructed by the one or more portable load-receiving load-bearing members 20 and the one or more items thereon.

With further reference to FIGS. 27-30, the moveable cover member 135 may include a front sidewall 215, a left sidewall 216, a right sidewall 217, a top cover 218, and an open backside 219 providing an opening into the interior 212 of the moveable cover member 135 for receiving (1) one or more portable load-receiving load-bearing members 20, or (2) one or more portable load-receiving load-bearing members 20 and one or more items thereon, when the moveable cover member 135 is directed to the operating position (or supporting position) effective as a support member with the top cover 218 disposed over the one or more portable load-receiving load-bearing members 20 or over the one or more portable load-receiving load-bearing members 20 and the one or more items thereon.

As stated above, although an assembly 100 of this disclosure may be built to scale, for purposes of moving building materials including, but not limited to, bundles of roof shingles 10, the loading assembly 102 may be configured to operably hold up to or about 2494.8 kg total (5500.0 pounds total) per load on the top cover 218 as described below. As such, in an embodiment, the moveable cover member 135 may include one or more structural reinforcement members selected according to a known or anticipated maximum weight to be supported on top of the moveable cover member 135. For example, in an embodiment as shown in FIG. 30, one or more structural reinforcement members may include, but are not limited to, one or more gussets 228 and/or the like (e.g., angle iron), I-beams, rectangular tubing, and combinations thereof, disposed along an inner surface 229 of the top cover 218 interconnecting the left sidewall 216 and the right sidewall 217 in a manner effective to add structural support to the moveable cover member 135. In an embodiment, one or more structural reinforcement members may also include one or more gussets including, but not limited to, a lower front sidewall gusset 227A interconnecting the left sidewall 216 and the right sidewall 217 and/or an upper front sidewall gusset 227B interconnecting the left sidewall 216, the right sidewall 217 and the top cover 218 (see FIG. 30).

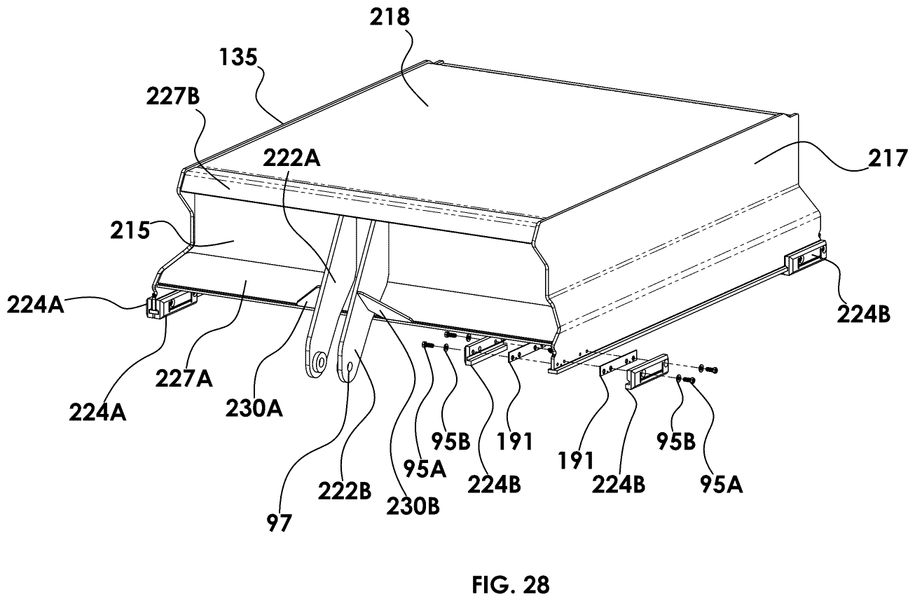

In an embodiment, the loading guide rails 205A and 205B may include upper linear guide channels 209A and 209B comprising elongate slots of a constant or substantially constant width. In an embodiment, each of the guide channels 209A and 209B may comprise a length up to or about a length of the corresponding loading guide rails 205A and 205B as shown in FIG. 25. In an embodiment, the left sidewall 216 and the right sidewall 217 of the moveable cover member 135 may include planar or substantially planar bottom surfaces configured to slidably mate with the guide channels 209A and 209B. As shown in FIG. 30, in an embodiment, the left sidewall 216 and the right sidewall 217 of the moveable cover member 135 may include planar or substantially planar elongated slide pads 225 and 226 and/or the like disposed along the bottoms of the left sidewall 216 and the right sidewall 217, wherein the slide pads 225 and 226 are configured to slidably mate with the guide channels 209A and 209B as shown in FIG. 27. In an embodiment, one or both of the left sidewall 216 and the right sidewall 217 may include one or more wear pads 224A and 224B similar to those described above (see FIG. 28).

As shown in FIG. 27, in an embodiment, the loading guide rails 205A and 205B may be provided as rectangular tubing and/or the like with guide channels 209A and 209B disposed along an upper surface of each of the loading guide rails 205A and 205B for receiving the slide pads 225 and 226 including the one or more wear pads 224A and 224B, and optionally one or more shims 191, therein. In an embodiment, the loading guide rails 205A and 205B may include one or more other multi-sided configurations. In an embodiment, the loading guide rails 205A and 205B may be provided as cylindrical tubular members with guide channels 209A and 209B disposed along an uppermost point of each of the cylindrical tubular members. In an embodiment, the loading guide rails 205A and 205B and the off-loading guide rails 109A and 109B may be provided as like or substantially the same construction. In an embodiment, the loading guide rails 205A and 205B and the off-loading guide rails 109A and 109B may be provided in a dissimilar configuration.

With further reference to FIG. 27, in an embodiment, the loading assembly 102 may include a cross member 213 interconnecting the female mating members 199B and 199D (see also FIG. 25) wherein the cross member 213 is configured to receive a first end of the one or more second horizontal linear actuators 220 in releasable attachment thereto. As further shown, the front sidewall 215 of the moveable cover member 135 may be configured to receive a second end of the one or more second horizontal linear actuators 220 in releasable attachment thereto in a manner effective such that the one or more second horizontal linear actuators 220 are disposed below the moveable cover member 135.

Still referring to FIG. 27, in an embodiment, the one or more second horizontal linear actuators 220 may include one or more double-acting hydraulic cylinders 220 wherein (1) a bore at a tail end 214A of the double-acting hydraulic cylinder 220 may be attached to one or more attachment surfaces 221A and 221B (or “mounting surfaces 221A and 221B”) located on the cross member 213 of the loading assembly 102 at a vertical position above an assembly support surface 1000, and (2) a distal end 214B of a drive rod of the double-acting hydraulic cylinder 220 may be attached to one or more attachment surfaces 222A and 222B (or “mounting surfaces 222A and 222B”) on the moveable cover member 135 at a vertical position above the assembly support surface 1000 that is the same or substantially similar to the point of attachment of the tail end 214A with the one or more attachment surfaces 221A and 221B. Without limiting the disclosure, in an embodiment the attachment surfaces 221A and 221B and the attachment surfaces 222A and 222B may be provided as planar type projections with apertures there through (see apertures 96 of attachment surfaces 221A and 221B in FIG. 25, and apertures 97 of attachment surfaces 222A and 222B in FIG. 28). With reference to FIG. 28, in an embodiment, a moveable cover member 135 may also include one or more structural reinforcement members including, but not limited to one or more gussets 230A and 230B and/or the like interconnecting the lower front sidewall gusset 227A of the front sidewall 215 with one or both of the one or more attachment surfaces 222A and 222B.

In an embodiment, the double acting hydraulic cylinder 220 may be attached to one or both of the attachment surfaces 221A and 221B and the attachment surfaces 222A and 222B via fasteners such as pins, socket head screws, flange bolts and flange nuts, hex bolts and hex nuts, and clips including, but not limited to, spring clips or other clips (see hex bolt 180A, washers 180B, and hex nuts 180C in FIG. 27). In another embodiment, the one or more second horizontal linear actuators 220 may be provided as one or more pneumatic cylinders. In another embodiment, the one or more second horizontal linear actuators 220 may be provided as mechanical actuators (e.g., screw jacks).

In an embodiment, the one or more attachment surfaces 221A and 221B may be centrally located on the cross member 213, and the mounting surfaces 222A and 222B may be centrally located on the front sidewall 215 of the moveable cover member 135 as shown in FIG. 27, effective for securing the one or more second horizontal linear actuators 220 in line along the longitudinal centerline C1 of the assembly 100 and parallel or substantially parallel to the planar horizontal surface 1000 in a manner effective to prevent or otherwise minimize horizontal side-loading of the one or more second horizontal linear actuators 220 during operation. As described below, the one or more second horizontal linear actuators 220 of the assembly 100 may be configured to direct the moveable cover member 135 horizontally a maximum distance in either direction according to the length of the loading guide rails 205A and 205B, the size and/or type of the one or more second horizontal linear actuators 220 (e.g., stroke length), and combinations thereof, effective to locate and hold the moveable cover member 135 in both a non-operating position and an operating position as described above.

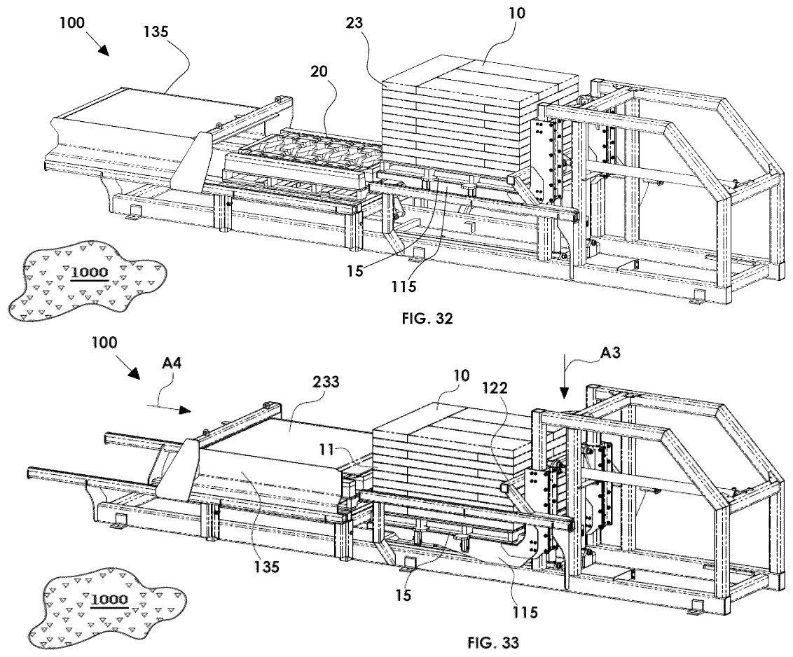

In an embodiment of operation of the assembly 100 for purposes of separating stacked bundles of roof shingles 10 into at least two separate stacks or loads, one or more operators may place at least one portable load-receiving load-bearing member 20 onto the loading platform 130 of the assembly 100 either manually or via a lifting device, and one or more operators may place at least one portable load-carrying load-bearing member 15 holding a load of stacked bundles of roof shingles 10 onto the support surface 116 of the off-loading platform 115 of the assembly 100 either manually or via a lifting device with the portable load-carrying load-bearing member 15 being set at an abutment position with the one or more stop members 155A and 155B as shown in FIG. 32. In a commercial setting, a plurality of portable load carrying load bearing members 15, each holding stacked bundles of roof shingles 10, may be stored in one or more designated on-site locations and one or more lifting devices may be used by one or more operators to transport a desired number of portable load-carrying load-bearing members 15, each holding stacked bundles of roof shingles 10, from one or more of the on-site locations onto one or more assemblies 100 that may be in use at the commercial location.

In an embodiment, once a portable load-receiving load-bearing member 20 and a portable load-carrying load-bearing member 15 carrying stacked bundles of roof shingles 10 are operably positioned on the assembly 100, one or more operators of the assembly 100 may direct the off-loading platform 115 to a first off-loading position via the one or more first vertical linear actuators 118A and 118B (see directional arrow A3 in FIG. 33), and direct the moveable cover member 135 to an operating position via the one or more second horizontal linear actuators 220 (see directional arrows A4 in FIG. 33). As shown in FIG. 33, at the operating position, the support surface 116 of the off-loading platform 115 may be located at a vertical position relative to the assembly support surface 1000 effective to position a desired number of rows of the stacked bundles of roof shingles 10 at a vertical position greater than or equal to a vertical position of the outer surface 233 of the top cover 218 of the moveable cover member 135. In this non-limiting example, the off-loading platform 115 is positioned to separate the stacked bundles of roof shingles 10 into two separate equal or substantially equal rows of bundles of roof shingles 10 (e.g., depicted in FIG. 33 including (1) a particular number of rows of bundles of roof shingles 10 positioned at a vertical position greater than or equal to the vertical position of the outer surface 233 (referred to herein as “upper load portion 13”), and (2) a particular number of rows of bundles of roof shingles 10 positioned at a vertical position lower than the top cover 218 (referred to herein as “lower load portion 14”). As further shown, when the off-loading platform 115 is set to a first off-loading position, then the push member 122 of the assembly 100 is disposed in a first position or retracted position at a vertical position that is the same or substantially similar as a vertical position of a bottommost row 11 of bundles of roof shingles 10 of the upper load portion 13.

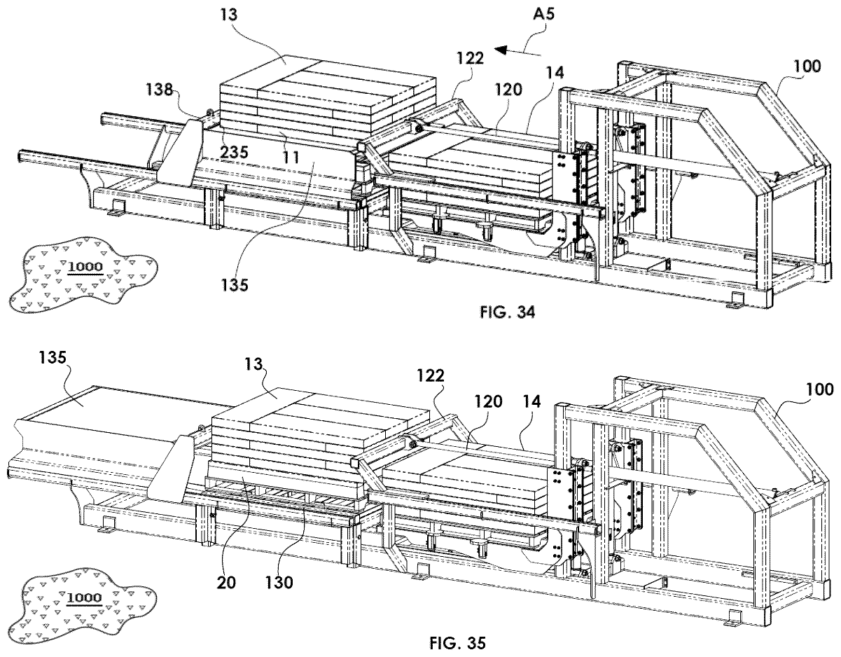

Referring to FIG. 34, once the off-loading platform 115 is set to the first off-loading position and the moveable cover member 135 is set to the operating position, the push member 122 may be directed from the retracted position to a second position or extended position (see directional arrow A5) effective to direct the upper load portion 13 off the stacked bundles of roof shingles 10 onto the outer surface 233 of the top cover 218 of the moveable cover member 135 with the lower load portion 14 remaining on the off-loading platform 115 as shown. In an embodiment as described in this paragraph, the moveable cover member 135 may also be referred to as a “first load-receiving support member,” and the outer surface 233 of the top cover 218 of the moveable cover member 135 may also be referred to as a “first load-receiving support surface” of the loading assembly 102 of the assembly 100.

With further reference to FIG. 34, in an embodiment, at least the bottommost row 11 of bundles of roof shingles 10 of the upper load portion 13 may be set in an abutment position with the rear surface 235 of the loading stop member 138. As understood by the skilled artisan, a plurality of rows of bundles of roof shingles 10 may be set in an abutment position with the rear surface 235 of the loading stop member 138 according to the height of the rear surface 235 and the height of each of the rows of stacked bundles of roof shingles 10 (e.g., the height of the rear surface 235 is the same or substantially similar as the height of two rows of bundles of roof shingles 10). In addition, in an embodiment, an extended position of the push member 122 may include a fully extended position and/or a partially extended position of the one or more first horizontal linear actuators 120.

Once the upper load portion 13 is operably located on the outer surface 233 of the top cover 218 as shown in FIG. 34, the moveable cover member 135 may then be directed to a non-operating position (or retracted position) (see directional arrow A5) via the one or more second horizontal linear actuators 220 whereby the loading stop member 138 is configured to maintain the upper load portion 13 in place above the loading platform 130 and the portable load-receiving load-bearing member 20 thereon, allowing the upper load portion 13 to descend or otherwise move downward to a resting position directly on the portable load-receiving load-bearing member 20 once the moveable cover member 135 is directed to the non-operating position as shown in FIG. 35. In an embodiment, the loading platform 130 may also be referred to as a “second load-receiving support member” and the support surface 132 of the loading platform 130 may also be referred to as a “second load-receiving support surface” of the loading assembly 102 of the assembly 100 for holding at least one portable load-receiving load-bearing member 20 with a load or a portion of a load thereon as shown in FIG. 35.

In an embodiment, the portable load-receiving load-bearing member 20 including the upper load portion 13 thereon may then be removed from the loading platform 130 via a lifting device and replaced with a second portable load-receiving load-bearing member 20 via a lifting device and/or manually, wherein the second portable load-receiving load-bearing member 20 is configured to receive the lower load portion 14, or at least a part of the lower load portion 14, from the off-loading platform 115.

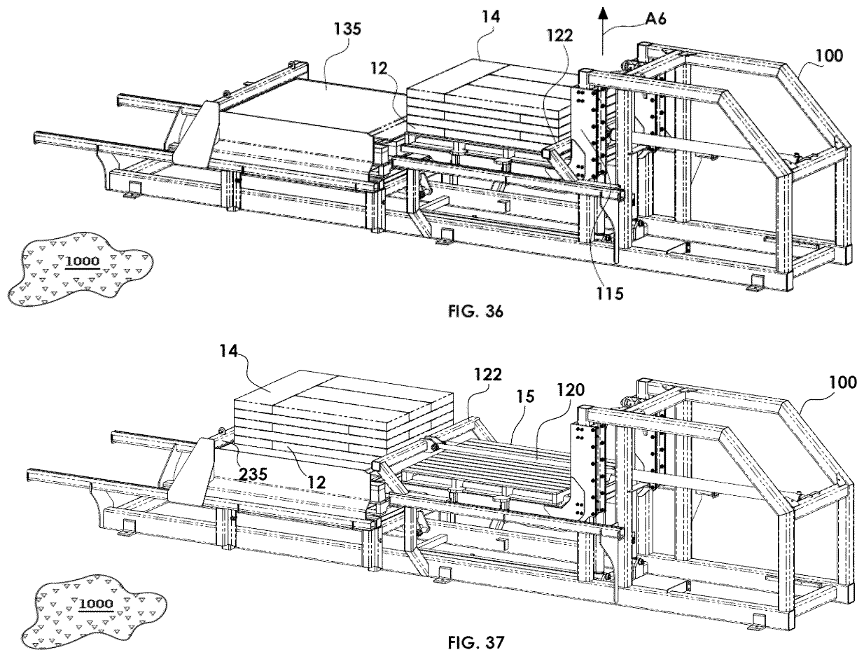

With reference to FIG. 36, when the one or more first horizontal linear actuators 120 are set to the retracted position with the push member 122 located rearward of the lower load portion 14, then the off-loading platform 115 may be directed to a second off-loading position via the one or more first vertical linear actuators 118A and 118B (see directional arrow A6), at a vertical position greater than the first off-loading position, and the moveable cover member 135 may again be directed to the operating position as shown. When the off-loading platform 115 is set to the second off-loading position, then the push member 122 of the assembly 100 is disposed in the retracted position at a vertical position that is the same or substantially similar as a vertical position of a bottommost row 12 of bundles of roof shingles 10 of the upper load portion 14 as depicted in FIG. 36.

Referring to FIG. 37, once the off-loading platform 115 is set to the second off-loading position and the moveable cover member 135 is set to the operating position, the push member 122 may again be directed from the retracted position to the extended position effective to direct the lower load portion 14 off the portable load-carrying load-bearing member 15 onto the outer surface 233 (see FIG. 33) of the top cover 218 of the moveable cover member 135 with the portable load-carrying load-bearing member 15 remaining on the off-loading platform 115 as shown. Similar as described above, in an embodiment, at least the bottommost row 12 of bundles of roof shingles 10 of the lower load portion 14 may be set in an abutment position with the rear surface 235 of the loading stop member 138 as depicted in FIG. 37.

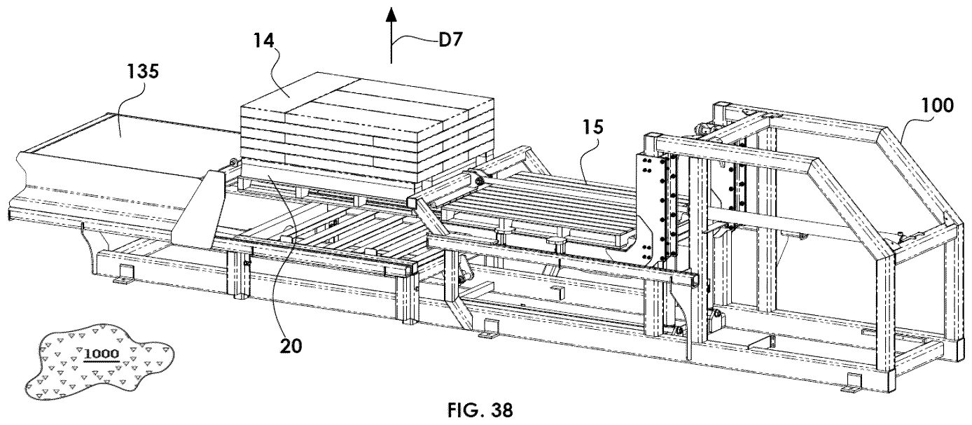

Once the lower load portion 14 is operably located on the outer surface 233 of the top cover 218 of the moveable cover member 135 as shown in FIG. 37, the moveable cover member 135 may then be directed to the non-operating position, whereby the loading stop member 138 is configured to maintain the lower load portion 14 in place above the second portable load-receiving load-bearing member 20 allowing the lower load portion 14 to descend or otherwise move downward to a resting position directly on the second portable load-receiving load-bearing member 20. As depicted in FIG. 38, the second portable load-receiving load-bearing member 20, including the lower load portion 14 thereon, may then be removed from the loading platform 130 (see directional arrow D7) via a lifting device and the portable load-carrying load-bearing member 15 may be removed from the off-loading platform 115 via a lifting device or manually. The above process as depicted in FIGS. 32-38 may be repeated as desired or as may otherwise be required for a particular operation. In an embodiment as described above, a single lifting device or multiple lifting devices may be employed for an operation as described above.

In an embodiment, the outer surface 233 of the top cover 218 of the moveable cover member 135 may be constructed from one or more materials and/or include one or more finishes and/or one or more coatings effective to promote operable movement of one or more items across the outer surface 233 with limited surface friction and/or without snagging or catching of the one or more items located on the outer surface 233 of the top cover 218. In an embodiment, the outer surface 233 of the top cover 218 may include a non-coated surface (e.g., a raw metal outer surface and/or the like). In an embodiment, the outer surface 233 of the top cover 218 may include a polished surface. In an embodiment, the outer surface 233 of the top cover 218 may include a coated surface. Suitable coated surfaces may include, but are not limited to, an epoxy resin outer surface, a powder coating outer surface, a thermal coating outer surface, a galvanized outer surface, an electrochemical coating outer surface, and a painted outer surface. In an embodiment, the outer surface 233 may include a corrugated-type surface including a plurality of elongated raised surfaces for supporting one or more items thereon and promoting operable movement across the outer surface 233.

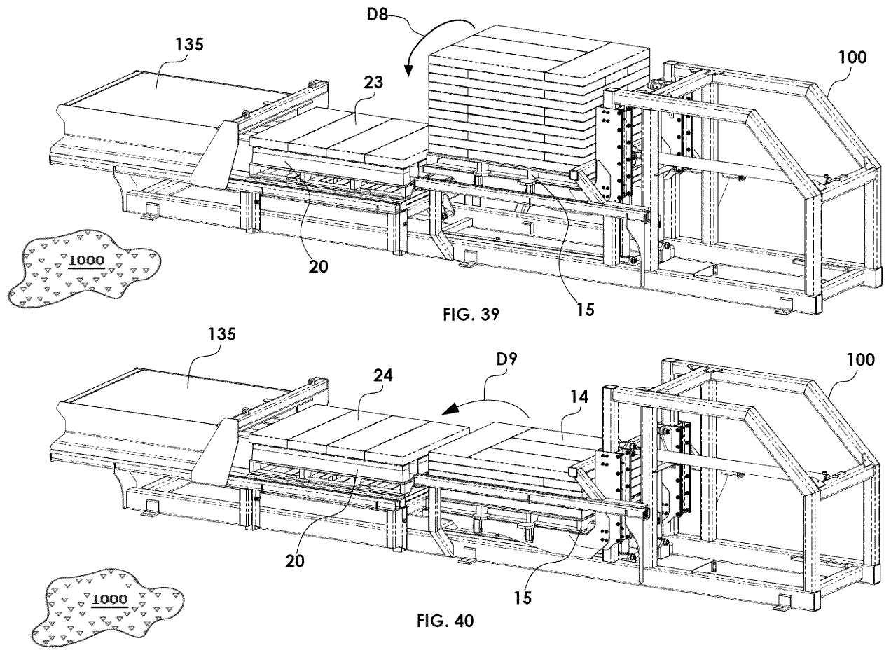

Referring to FIGS. 39 and 40, in an embodiment, to prevent or minimize any possible damage to a portable load-receiving load-bearing member 20 and/or a bottommost row 11 of bundles of roof shingles 10 of the upper load portion 13, with the moveable cover member 135 set at the non-operating position as shown, and before directing the upper load portion 13 off the stacked bundles of roof shingles 10 onto the portable load-receiving load-bearing member 20 as described above, one or more operators may first remove an uppermost row 23 of bundles of roof shingles 10 from the stack of bundles of roof shingles 10 located on the portable load-carrying load-bearing member 15 and place the uppermost row 23 on top of the portable load-receiving load-bearing member 20 (see directional arrow D8) wherein the uppermost row 23 becomes the bottommost row of the upper load portion 13 to be formed on the portable load-receiving load-bearing member 20. Likewise, before directing the lower load portion 14 off the stacked bundles of roof shingles 10 onto a second portable load-receiving load-bearing member 20 as described above, one or more operators may first remove an uppermost row 24 of bundles of roof shingles 10 from the lower load portion 14 and place the uppermost row 24 on top of the second portable load-receiving load-bearing member 20 (see directional arrow D9) wherein the uppermost row 24 becomes the bottommost row of the lower load portion 14 to be formed on the second portable load-receiving load-bearing member 20. In another embodiment, a row of bundles of roof shingles 10 forming the bottommost row of the upper load portion 13 and/or the lower load portion 14 may originate from one or more sources other than the stack of bundles of roof shingles 10 located on the off-loading platform 115.

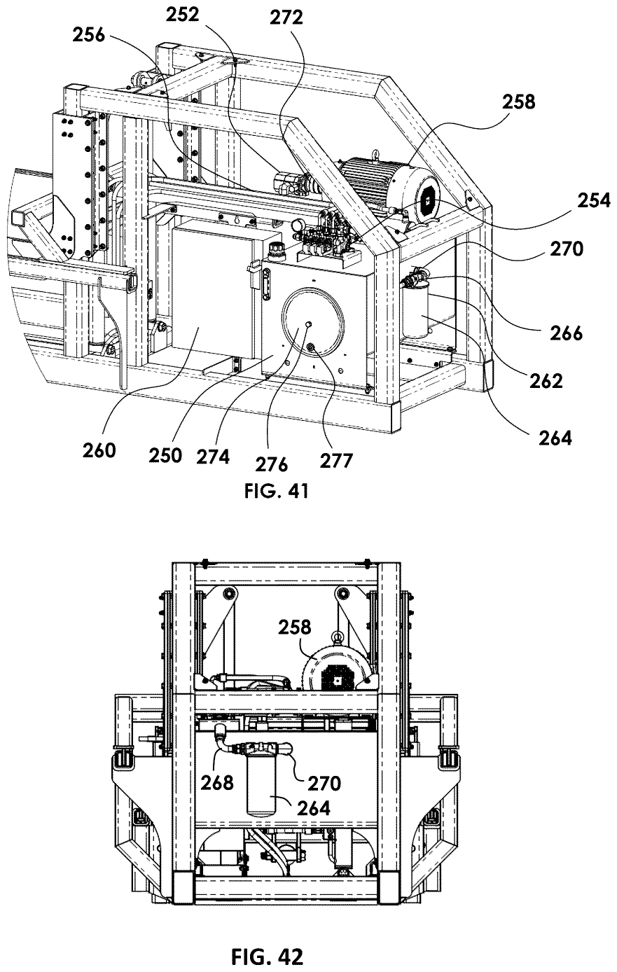

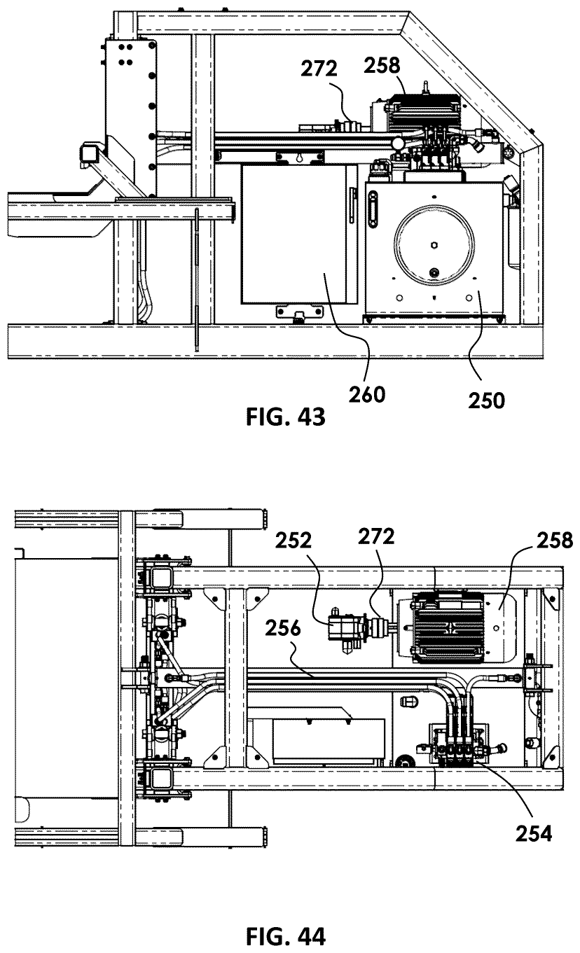

With reference now to FIGS. 41-44, in an embodiment, the one or more first vertical linear actuators 118A and 118B, the one or more first horizontal linear actuators 120, and the one or more second horizontal linear actuators 220 (collectively “assembly actuators”) may form part of a hydraulic powering system of the assembly 100. In an embodiment, a hydraulic powering system may include (1) at least one hydraulic fluid reservoir 250 such as a container or tank, for holding one or more hydraulic fluids, (2) at least one hydraulic pump 252 in fluid communication with the at least one hydraulic fluid reservoir 250, and (3) at least one directional control valve 254 in fluid communication with the at least one hydraulic pump 252 for controlling conveyance of the hydraulic fluid(s) to the assembly actuators via separate hydraulic fluid lines 256, each hydraulic fluid line being in fluid communication with a corresponding actuator and located at a rearward part of the off-loading assembly 101 of the assembly 100. In addition, the hydraulic powering system may include at least one electric motor 258 configured to drive (1) the at least one hydraulic pump 252 and (2) an electrical power and control assembly housed in an electrical enclosure 260 and in electrical communication with the at least one electric motor 258, the electrical power and control assembly comprising various electrical components of the assembly 100.

As further shown in FIGS. 41-44, a hydraulic powering system of the assembly 100 may include a hydraulic fluid filtration system configured to collect one or more contaminants from the hydraulic fluid(s) and preventing the contaminants from entering the at least one hydraulic fluid reservoir 250. For example, in an embodiment, the hydraulic powering system may include a filter assembly 262 including at least a filter element 264 and a filter head 266. As understood by the skilled artisan, the filter head 266 may be configured as a top part of the filter assembly 262 and may provide a point of attachment for the filter element 264. In an embodiment, an inlet of the filter head 266 may be configured to receive hydraulic fluid(s) from the directional control valve 254 via a hydraulic fluid inlet line 268 and to convey the filtered hydraulic fluid(s) from the filter assembly 262 to the at least one hydraulic fluid reservoir 250 via a hydraulic fluid outlet line 270 (e.g., an NPT elbow fitting and/or one or more hydraulic fluid lines).

Other hydraulic fluid filtration system components may include one or more components understood by the skilled artisan as commonly included in a hydraulic fluid filtration system, such as a flexible coupling 272 connecting an output shaft of the at least one electric motor 258 to an input shaft of the at least one hydraulic pump 252. In an embodiment, the flexible coupling 272 may include a first steel collar that fits over the output shaft of the at least one electric motor 258 and is held in place by a key, and a second steel collar that fits over the keyed input shaft of the at least one hydraulic pump 252.

In an embodiment, the at least one hydraulic fluid reservoir 250 may include a standard JIC type reservoir of a desired capacity, for example, (1) 189.3 liters (50.0 gallons), (2) 227.1 liters (60.0 gallons), or another capacity, according to the hydraulic fluid demands of a particular assembly 100. As shown, a standard JIC type reservoir 250 includes at least one reservoir access cover 274 with a rubber gasket or other seal along the perimeter of the access cover 274 configured to form a seal once the access cover 274 is secured to the reservoir 250 via a retention bolt 276 connected to a bracket inside the reservoir 250, whereby tightening the retention bolt 276 pinches the bracket and the access cover 274 together to form the seal. As shown, the access cover 274 may be provided with a threaded drain plug 277 threadedly mated with a threaded drain hole on the access cover 274, whereby removal of the drain plug 277 allows a desired volume of hydraulic fluid stored within the reservoir 250 to be drained as desired (e.g., for servicing the reservoir 250 or changing the hydraulic fluid of the hydraulic powering system).

A hydraulic pump provided as part of a hydraulic powering system of this disclosure may vary as desired or as required for one or more applications. For example, a hydraulic pump may be selected according to one or more factors including, but not limited to (1) a required flow rate of the hydraulic powering system, (2) operating pressure of the hydraulic powering system, (3) the type(s) of hydraulic fluid used in the hydraulic powering system, and (4) torque rating. In an embodiment, the at least one hydraulic pump 252 may be provided as a two-stage gear pump 252. In a non-limiting example, a two-stage gear pump 252 may include a first-stage gear set configured to pump hydraulic fluid at a rate of or about 22.7 liters (6.0 gallons) per minute and a second-stage gear set configured to pump hydraulic fluid at a rate of or about 106.0 liters (28.0 gallons) per minute. In an embodiment, when the operating pressure of the two-stage gear pump 252 is elevated to a point where the two-stage gear pump 252 would otherwise overpower the at least one electric motor 258, causing the at least one electric motor 258 to stall, the second stage gear set automatically disengages and the first stage gear set continues pumping at a pressure and flow rate that will not overpower or stall the at least one electric motor 258, allowing a hydraulic powering system of the assembly 100 to minimize the size of the at least one electric motor 258 while still providing sufficient power to move loads across a wide range of load weight requirements for the assembly 100. As such, for use as part of the assembly 100 for moving or transferring one or more bundles of roof shingles 10, in an embodiment, the at least one electric motor 258 may include a CEM4314 T 60.0 HP 364TC 230/460 Totally Enclosed Fan-Cooled (TEFC) Motor commercially available from ABB Motors and Mechanical Inc., Fort Smith, Arkansas, U.S.A., and/or the like.

In an embodiment, the at least one directional control valve 254 provided as part of the hydraulic powering system may vary as desired or as required for one or more applications. For example, the at least one directional control valve 254 may be selected according to one or more factors including, but not limited to (1) the number of hydraulic cylinders of the hydraulic powering system, (2) the required flow rate of the hydraulic powering system, (3) the operating pressure of the hydraulic powering system, (4) application needs (e.g., directional control, pressure regulation, fluid flow control, the type of hydraulic fluid, and the operating temperature of the hydraulic powering system). In an embodiment, the at least one directional control valve 254 may be provided as a five-section 12 VDC electric solenoid operated directional control valve commercially available from Salami Spa, Modena, Italy, and/or the like.

In an embodiment, an electrical power and control assembly, including an electrical enclosure 260 provided as part of a hydraulic powering system, may vary as desired or as required for one or more applications. For example, an electrical power and control assembly and the electrical enclosure 260 may be selected according to one or more factors including, but not limited to the power requirements of the assembly 100 including the power requirements of the at least one hydraulic pump 252 and the at least one electric motor 258.

In an embodiment, an electrical enclosure 260 may be configured to house various parts of an electrical power and control assembly, including but not limited to, one or more electrical plug inlets, one or more electrical plug outlets, one or more controls in electrical communication with control circuitry of the assembly 100, including one or more monitors, one or more electrical connectors, one or more conducting path controls (e.g., one or more relays, resistors, switches, momentary switches, latching switches, breakers, contactors, solenoids, fuses, starter controllers, soft starters, variable frequency drives, and combinations thereof). An electrical power and control assembly may also include one or more breakers, one or more relays, one or more timers, programmable logic controllers (“PLC”), one or more transformers, one or more fuses, and one or more terminal blocks.

In an embodiment, an electrical power and control assembly of the assembly 100 may include incoming high-voltage (230 VAC) power routed through a master ON/OFF switch and converted to low-voltage 12 VDC power for controlling the at least one directional control valve 254 while also providing sufficient power for the at least one electric motor 258. In an embodiment, an electrical power and control assembly of the assembly 100 may be protected by three 60-amp buss-style fuses. In an embodiment, the electrical enclosure 260 may include an electrical control panel commercially available from Siemens, Munich, Germany, and/or the like.

In an embodiment, an electrical power and control assembly of the assembly 100 may include wireless data transmission. For example, an electrical power and control assembly may include a remote control system for operating a hydraulic powering system of the assembly 100. In an embodiment, the remote control system may include a six-function receiver and IP transmitter commercially available from Lodar Ltd, Walsall, West Midlands, England, and/or the like.

The hydraulic fluid lines 256 provided as part of a hydraulic powering system may vary as desired or as required for one or more applications. For example, the hydraulic fluid lines 256 may be selected according to one or more factors including, but not limited to (1) the operating pressure of the hydraulic powering system, (2) the required flow rate of the hydraulic powering system, (3) a temperature range of the hydraulic fluid, (4) bend-radius requirements for the hydraulic fluid lines 256, and (5) required lengths for one or more of the hydraulic fluid lines 256. In an embodiment, each of the hydraulic fluid lines 256 may include high-pressure hydraulic hoses rated to 3500 psi.

In an embodiment, one or more hydraulic fluids of a hydraulic powering system of the assembly 100 may include, but are not limited to, one or more mineral-based fluids and/or one or more synthetic fluids. In an embodiment, the one or more hydraulic fluids may include mineral oil having a viscosity from or about 12.0 cSt to or about 75.0 cSt.

Although an assembly 100 may be constructed from one or more materials as desired or as required for one or more operations (e.g., one or more metals, one or more woods, one or more polymeric materials, one or more composite materials, and combinations thereof), in an embodiment of the assembly 100 configured for moving or transferring one or more bundles of roof shingles 10, the main frame 103 may be constructed from one or more metals, whereby the individual components making up the main frame 103 may be secured via welds, fasteners, adhesive, and combinations thereof. Suitable metals may include, but are not limited to steel, stainless steel, aluminum, and combinations thereof.

In an embodiment of the main frame 103 of the assembly 100 constructed of one or more metals, the first and second elongated members 105A and 105B, the first, second and third cross members 106A, 106B and 106C, the vertical support members 124A-124F, the upper support members 125A-125D and the first and second cross members 126A and 126B may be provided as I-beams, H-beams, wide-flange beams (or “W-beams”), channel beams (or “C-beams”), T-beams, angle beams (or “L-shaped beams”), hollow structural sections (or “HSS beams”), and combinations thereof.

In an embodiment including an assembly 100 constructed of one or more metals, one or more front wear pads 152, one or more rear wear pads 153, and one or more wear pads 190A and 190B may be constructed of materials including, but not limited to, UHMW, nylon, bronze, ABS, and combinations thereof.

In another embodiment, it is herein contemplated that the assembly 100 may be used to move a load or a portion of a load with or without the use of one or more portable load-carrying load-bearing members 15 and/or portable load-receiving load-bearing members 20. For example, the assembly 100 may be used to move stackable items from a portable load-carrying load-bearing member 15 to at least a first portable load-receiving load-bearing member 20, as described above. However, in other embodiments, the assembly 100 may be used to move stackable items that are placed directly onto the off-loading support surface 115 of the off-loading assembly 101 without the use of a portable load-carrying load-bearing member 15. Likewise, stackable items may be transferred from the off-loading assembly 101 to a support surface of the loading assembly 102 without the use of a portable load-receiving load-bearing member 20, or stackable items may be transferred from the off-loading assembly 101 directly onto a portable load-receiving load-bearing member 20 positioned on the loading assembly 102.

In another embodiment, the assembly 100 may be configured with a pull-type load-transfer system in place of, or in addition to, a push-type configuration. In such an embodiment, either the off-loading assembly 101, the loading assembly 102, or both, may include an actuator operatively coupled to a pull member, cable, linkage, or other load-engaging element configured to draw a load or a portion of the load from the off-loading assembly 101 toward the loading assembly 102. The pull-type load-transfer system may be extendable, retractable, pivotable, or otherwise movable to initiate movement of the load or a portion of the load in a pulling direction, thereby transferring the load or the portion of the load onto the loading assembly 102. Any suitable actuator, including hydraulic, pneumatic, mechanical, or electric actuators, may be employed as part of the pull-type load-transfer system.

A system, apparatus, assembly, and method of the present disclosure may be described according to one or more of the following Embodiments.

Embodiment 1. An assembly, comprising:
a first subsystem; and
a second subsystem;
wherein the first subsystem is configured to support a load and to effect movement of the load or a portion of the load toward the second subsystem; and
wherein the second subsystem is configured to receive the load or the portion of the load from the first subsystem and to reposition the load or the portion of the load from a first location within the second subsystem to a second location within the second subsystem.

Embodiment 2. The assembly of Embodiment 1, wherein the first location within the second subsystem is at a vertical position greater than the second location within the second subsystem.

Embodiment 3. The assembly of Embodiment 1, wherein repositioning the load or the portion of the load from the first location to the second location includes causing the load or the portion of the load to descend from the first location to the second location.

Embodiment 4. The assemlby of Embodiment 1, wherein the second subsystem comprises a load-transition assembly including a moveable support member and at least a first stop member that cooperate such that movement of the moveable support member from a supporting position for the load or the portion of the load to a retracted position effects descent of the load or the portion of the load from the first location to the second location.

Embodiment 5. The assembly of Embodiment 4, wherein the moveable support member comprises a first load-receiving support surface defining the first location within the second subsystem.

Embodiment 6. The assembly of Embodiment 1, wherein the second subsystem includes a first load-receiving support surface at a first vertical position and a second load-receiving support surface at a second vertical position less than the first vertical position, and wherein the first load-receiving support surface is configured to receive the load or the portion of the load from the first subsystem.

Embodiment 7. The assembly of Embodiment 1, wherein the first subsystem includes a load-moving system having an adjustable off-loading support surface configured to be directed to a plurality of off-loading positions, wherein the second subsystem includes a first load-receiving support surface and a second load-receiving support surface, wherein the first load-receiving support surface, when in a supporting position located above the second load-receiving support surface, is positioned to receive the load or the portion of the load from the adjustable off-loading support surface when the adjustable off-loading support surface is set to a first off-loading position effective for directing the load or the portion of the load onto the first load-receiving support surface, and wherein the first load-receiving support surface is configured to move from the supporting position to a retracted position, thereby transferring the load or the portion of the load to the second load-receiving support surface.

Embodiment 8. The assembly of Embodiment 1, wherein the first subsystem includes a load-moving system having an adjustable off-loading support surface configured to be directed to a plurality of off-loading positions, wherein the second subsystem includes a first load-receiving support surface and a second load-receiving support surface, wherein the first load-receiving support surface, when in a supporting position located above the second load-receiving support surface, is positioned to receive a first portion of the load from the adjustable off-loading support surface when the adjustable off-loading support surface is set to a first off-loading position effective for directing the first portion of the load onto the first load-receiving support surface, and wherein the first load-receiving support surface is configured to move from the supporting position to a retracted position, thereby transferring the first portion of the load to the second load-receiving support surface.

Embodiment 9. The assembly of Embodiment 8, wherein the first portion of the load descends onto a first portable load-receiving load-bearing member located on the second load-receiving support surface.

Embodiment 10. The assembly of Embodiment 9, wherein, after replacement of the first portable load-receiving load-bearing member with a second portable load-receiving load-bearing member on the second load-receiving support surface, with the first load-receiving support surface in the supporting position and the adjustable off-loading support surface set to a second off-loading position effective for directing the second portion of the load onto the first load-receiving support surface, once the second portion of the load is on the first load-receiving support surface, the first load-receiving support surface is configured to move from the supporting position to the retracted position, thereby transferring the second portion of the load to the second portable load-receiving load-bearing member.

Embodiment 11. The assembly of Embodiment 1, wherein the first subsystem includes a load-moving system having an adjustable off-loading support surface configured to be directed to a plurality of off-loading positions, wherein, when the adjustable off-loading support surface is adjusted to a position effective for the load or the portion of the load to be directed toward the second subsystem, the load-moving system is configured to effect the movement of the load or the portion of the load toward the second subsystem.

Embodiment 12. The assembly of Embodiment 11, wherein the load-moving system includes a push assembly comprising one or more horizontal actuators, one or more guide rails, and a push member slidably engaged with the guide rails and configured to travel along the guide rails to effect the movement of the load or the portion of the load toward the second subsystem.

Embodiment 13. The assembly of Embodiment 8, wherein the adjustable off-loading support surface comprises one or more raised stop surfaces configured to position the load at a desired location atop the off-loading support surface.

Embodiment 14. The assembly of Embodiment 9, wherein the second load-receiving support surface includes one or more raised stop surfaces configured to position the first portable load-receiving load-bearing member at a desired location atop the second load-receiving support surface.

Embodiment 15. An assembly, comprising:
a first subsystem configured to support a load; and
a second subsystem operatively associated with the first subsystem;
wherein the first subsystem includes a load-moving system comprising an off-loading support surface configured to be directed to one or more off-loading positions, each off-loading position corresponding to a vertical position of the off-loading support surface selected according to a configuration of an intended portion of the load to be transferred to the second subsystem; and
wherein when the off-loading support surface is set to a first off-loading position, then the vertical position of the off-loading support surface corresponds to a vertical position associated with the intended portion of the load to be transferred to the second subsystem, and the load-moving system is configured to initiate movement of the intended portion of the load toward the second subsystem.

Embodiment 16. The assembly of Embodiment 15, wherein the off-loading support surface comprises one or more adjustable stop members configured to provide multiple stop positions for the load on the off-loading support surface.

Embodiment 17. The assembly of Embodiment 15, wherein the load-moving system includes one or more actuators configured to move the intended portion of the load toward the second subsystem.

Embodiment 18. The assembly of Embodiment 15, wherein the second subsystem includes a height-adjustable load-receiving support surface.

Embodiment 19. A method, comprising:
moving stackable items off a portable load-carrying load-bearing member using an assembly, including:
   a first subsystem configured to hold the portable load-carrying load-bearing member with the stackable items thereon; and
   a second subsystem configured to receive the stackable items from the first subsystem;
positioning the stackable items at a first location within the second subsystem; and
repositioning the stackable items from the first location to a second location within the second subsystem.

Embodiment 20. The method, of Embodiment 19, wherein the second location is defined by a load-receiving support surface of a first portable load-receiving load-bearing member.

Embodiment 21. An assembly comprising:
an off-loading assembly; and
a loading assembly;
wherein the off-loading assembly is configured to hold a load thereon and direct the load or a partial load onto the loading assembly;
wherein the loading assembly includes a first load-receiving surface for receiving the load or the partial load from the off-loading assembly; and
wherein the loading assembly is configured to transfer the load or the partial load off from the first load-receiving surface onto a second load-receiving surface of the loading assembly

Embodiment 22. The assembly of Embodiment 22, wherein the second load-receiving surface of the loading assembly is configured to hold at least a first portable load-receiving load bearing member; and wherein the loading assembly is configured to transfer the load or the partial load off from the first load-receiving surface onto the first portable load-receiving load-bearing member.

Embodiment 23. The assembly of Embodiment 22, wherein the off-loading assembly is configured to hold at least a first portable load-carrying load-bearing member; wherein the second load-receiving surface of the loading assembly is configured to hold at least a first portable load-receiving load-bearing member; and wherein the loading assembly is configured to transfer the load or the partial load off from the first load-receiving surface onto the first portable load-receiving load-bearing member.

Embodiment 24. An assembly, comprising:
an off-loading assembly; and
a loading assembly;
wherein the off-loading assembly is configured to hold a load thereon and move the load vertically to a plurality of set positions;
wherein the off-loading assembly is configured to direct the load or a partial load onto the loading assembly;
wherein the loading assembly includes a first load-receiving support surface for receiving the load or the partial load from the off-loading assembly; and
wherein the loading assembly is configured to transfer the load or the partial load off from the first load-receiving surface onto a second load-receiving support surface of the loading assembly.

Embodiment 25. A method, comprising:
moving stackable items off from an off-loading support surface onto one or more load-receiving support surfaces using an assembly, including:
   a first subsystem as described above; and
   a second subsystem as described above.

Embodiment 26. A method, comprising:
moving stackable items off from at least a first portable load-carrying load-bearing member onto at least one portable load-receiving load-bearing member using
   an assembly, including:
   a first subsystem as described above; and
   a second subsystem as described above.

Embodiment 27. A load-handling system, comprising:
a first subsystem including one or more positioning elements configured to align a selected portion of a load with a receiving structure of a second subsystem;
wherein the positioning elements may be adjustable to establish an alignment condition effective for directing the selected portion of the load from a first support surface of the first subsystem to a second support surface of the second subsystem.

Embodiment 28. A first subsystem and a second subsystem may be configured to cooperate in performing one or more transfer events in which a load or a selected portion of a load is transitioned from a first support surface associated with the first subsystem to a second support surface associated with the second subsystem. The first subsystem may include one or more structures configured to position the load or the selected portion of the load for a corresponding transfer event, and the second subsystem may include one or more structures configured to receive the load or the selected portion of the load during the transfer event. The one or more transfer events may be carried out in sequence or independently based on the arrangement or characteristics of the load.

Although the present disclosure is described above in terms of various exemplary embodiments and implementations, it should be understood that the various features and functionality described in one or more of the individual embodiments are not limited in their applicability to the particular embodiment with which they are described, but instead might be applied, alone or in various combinations, to one or more other embodiments whether or not such embodiments are described and whether or not such features are presented as being a part of a described embodiment. Thus, the breadth and scope of the claimed invention should not be limited by any of the above-described embodiments.

Persons of ordinary skill in the art will recognize that many modifications may be made to the present disclosure without departing from the spirit and scope of the disclosure. The embodiment(s) described herein are meant to be illustrative only and should not be taken as limiting the invention, which is defined in the claims.

I claim:

1. An assembly, comprising:
a first subsystem; and
a second subsystem;
wherein the first subsystem is configured to support a load and to effect movement of the load or a portion of the load toward the second subsystem; and
wherein the second subsystem is configured to receive the load or the portion of the load from the first subsystem and to reposition the load or the portion of the load from a first location within the second subsystem to a second location within the second subsystem.

2. The assembly of claim 1, wherein the first location within the second subsystem is at a vertical position greater than the second location within the second subsystem.

3. The assembly of claim 1, wherein repositioning the load or the portion of the load from the first location to the second location includes causing the load or the portion of the load to descend from the first location to the second location.

4. The assembly of claim 1, wherein the second subsystem comprises a load-transition assembly including a moveable support member and at least a first stop member that cooperate such that movement of the moveable support member from a supporting position for the load or the portion of the load to a retracted position effects descent of the load or the portion of the load from the first location to the second location.

5. The assembly of claim 4, wherein the moveable support member comprises a first load-receiving support surface defining the first location within the second subsystem.

6. The assembly of claim 1, wherein the second subsystem includes a first load-receiving support surface at a first vertical position and a second load-receiving support surface at a second vertical position less than the first vertical position, and wherein the first load-receiving support surface is configured to receive the load or the portion of the load from the first subsystem.

7. The assembly of claim 1, wherein the first subsystem includes a load-moving system having an adjustable off-loading support surface configured to be directed to a plurality of off-loading positions, wherein the second subsystem includes a first load-receiving support surface and a second load-receiving support surface, wherein the first load-receiving support surface, when in a supporting position located above the second load-receiving support surface, is positioned to receive the load or the portion of the load from the adjustable off-loading support surface when the adjustable off-loading support surface is set to a first off-loading position effective for directing the load or the portion of the load onto the first load-receiving support surface, and wherein the first load-receiving support surface is configured to move from the supporting position to a retracted position, thereby transferring the load or the portion of the load to the second load-receiving support surface.

8. The assembly of claim 1, wherein the first subsystem includes a load-moving system having an adjustable off-loading support surface configured to be directed to a plurality of off-loading positions, wherein the second subsystem includes a first load-receiving support surface and a second load-receiving support surface, wherein the first load-receiving support surface, when in a supporting position located above the second load-receiving support surface, is positioned to receive a first portion of the load from the adjustable off-loading support surface when the adjustable off-loading support surface is set to a first off-loading position effective for directing the first portion of the load onto the first load-receiving support surface, and wherein the first load-receiving support surface is configured to move from the supporting position to a retracted position, thereby transferring the first portion of the load to the second load-receiving support surface.

9. The assembly of claim 8, wherein the first portion of the load descends onto a first portable load-receiving load-bearing member located on the second load-receiving support surface.

10. The assembly of claim 9, wherein, after replacement of the first portable load-receiving load-bearing member with a second portable load-receiving load-bearing member on the second load-receiving support surface, with the first load-receiving support surface in the supporting position and the adjustable off-loading support surface set to a second off-loading position effective for directing the second portion of the load onto the first load-receiving support surface, once the second portion of the load is on the first load-receiving support surface, the first load-receiving support surface is configured to move from the supporting position to the retracted position, thereby transferring the second portion of the load to the second portable load-receiving load-bearing member.

11. The assembly of claim 1, wherein the first subsystem includes a load-moving system having an adjustable off-loading support surface configured to be directed to a plurality of off-loading positions, wherein, when the adjustable off-loading support surface is adjusted to a position effective for the load or the portion of the load to be directed toward the second subsystem, the load-moving system is configured to effect the movement of the load or the portion of the load toward the second subsystem.

12. The assembly of claim 11, wherein the load-moving system includes a push assembly comprising one or more horizontal actuators, one or more guide rails, and a push member slidably engaged with the guide rails and configured to travel along the guide rails to effect the movement of the load or the portion of the load toward the second subsystem.

13. The assembly of claim 8, wherein the adjustable off-loading support surface comprises one or more raised stop surfaces configured to position the load at a desired location atop the off-loading support surface.

14. The assembly of claim 9, wherein the second load-receiving support surface includes one or more raised stop surfaces configured to position the first portable load-receiving load-bearing member at a desired location atop the second load-receiving support surface.

15. An assembly, comprising:
a first subsystem configured to support a load; and
a second subsystem operatively associated with the first subsystem;
wherein the first subsystem includes a load-moving system comprising an off-loading support surface configured to be directed to one or more off-loading positions, each off-loading position corresponding to a vertical position of the off-loading support surface selected according to a configuration of an intended portion of the load to be transferred to the second subsystem; and
wherein when the off-loading support surface is set to a first off-loading position, then the vertical position of the off-loading support surface corresponds to a vertical position associated with the intended portion of the load to be transferred to the second subsystem, and the load-moving system is configured to initiate movement of the intended portion of the load toward the second subsystem.

16. The assembly of claim 15, wherein the off-loading support surface comprises one or more adjustable stop members configured to provide multiple stop positions for the load on the off-loading support surface.

17. The assembly of claim 15, wherein the load-moving system includes one or more actuators configured to move the intended portion of the load toward the second subsystem.

18. The assembly of claim 15, wherein the second subsystem includes a height-adjustable load-receiving support surface.

19. A method, comprising:
moving stackable items off a portable load-carrying load-bearing member using an assembly, including:
a first subsystem configured to hold the portable load-carrying load-bearing member with the stackable items thereon; and
a second subsystem configured to receive the stackable items from the first subsystem;
positioning the stackable items at a first location within the second subsystem; and
repositioning the stackable items from the first location to a second location within the second subsystem.

20. The method of claim 19, wherein the second location is defined by a load-receiving support surface of a first portable load-receiving load-bearing member.
